(19) United States
(12) Patent Application Publication
(10) Pub. No.: US 2024/0072849 A1
(43) Pub. Date: Feb. 29, 2024

(54) METHODS AND APPARATUS FOR COMMUNICATIONS USING A RECONFIGURABLE INTELLIGENT SURFACE

(71) Applicant: HUAWEI TECHNOLOGIES CO., LTD., SHENZHEN (CN)

(72) Inventors: Ahmad Abu Al HAIJA, OTTAWA (CA); Mohammadhadi BALIGH, OTTAWA (CA)

(21) Appl. No.: 18/503,187

(22) Filed: Nov. 7, 2023

Related U.S. Application Data
(63) Continuation of application No. PCT/CN2021/094772, filed on May 20, 2021.

(51) Int. Cl. H04B 7/04; H04B 7/06; H04B 7/08

(52) U.S. Cl. CPC H04B 7/04013; H04B 7/06952; H04B 7/086

(57) ABSTRACT

Aspects of the present disclosure provide methods and devices that facilitate two-way redirection via a reconfigurable intelligent surface (RIS) when beam correspondence does not hold. A first embodiment includes using a wide-beam redirection via RIS in which the RIS is configured to redirect the beam incident on the RIS in either direction such that the redirected beam can encompass the deviation of the redirected direction and still reach the destination. A second embodiment includes partitioning the RIS, or using multiple different RISs, where each part, or different RIS, is configured for each direction of communication. A third embodiment includes using time division-duplexing (TDD) such that the RIS is configured to transmit in one direction at a time.

### CROSS-REFERENCE TO RELATED APPLICATION

This application is a continuation of International Patent Application No. PCT/CN2021/094772, filed May 20, 2021, entitled “METHODS AND APPARATUS FOR COMMUNICATIONS USING A RECONFIGURABLE INTELLIGENT SURFACE”, the contents of which are incorporated by reference herein its entirety.

### TECHNICAL FIELD

The present disclosure relates generally to wireless communications, and in particular embodiments, beam correspondence in two-way redirection when using at least one reconfigurable intelligent surface (RIS).

### BACKGROUND

In some wireless communication systems, user equipments (UEs) wirelessly communicate with a base station (or gNB) to send data to the base station and/or receive data from the base station. A wireless communication from a UE to a base station is referred to as an uplink (UL) communication. A wireless communication from a base station to a UE is referred to as a downlink (DL) communication. A wireless communication from a first UE to a second UE is referred to as a sidelink (SL) communication or device-to-device (D2D) communication. A wired or wireless communication from a first base station to a second base station is referred to as a backhaul communication.

Resources are required to perform uplink, downlink and sidelink communications. For example, a base station may wirelessly transmit data, such as a transport block (TB), to a UE in a downlink transmission at a particular frequency and over a particular duration of time. The frequency and time duration used are examples of resources.

A Reconfigurable Intelligent Surface (RIS) consists of an array of elements that can change the phase (and also amplitude, polarization, or even the frequency) of the incident wave/signal. Hence, between a transmitter and receiver communication with the help of the RIS, the RIS elements can be configured to provide desired phase-shifts for the incident-waves from the transmitter to be redirected to a desired direction towards the receiver. Configuring a RIS for redirection of a beam in one direction between two devices may result in an undesired redirection in an oppose direction between the same two devices. Methods for maintaining beam correspondence while using an RIS in two way direction communication may be advantageous to communication systems.

### SUMMARY

Aspects of the present disclosure pertain to the beam correspondence when using a RIS in a two-way redirection (TWR) scenario. A TWR scenario may also be referred to as a bi-directional transmission scenario that includes transmission occurring in two directions. TWR or bi-directional transmission may include, for example, a base station (BS) and a UE communicating in uplink (UL) and downlink (DL) directions, or two UEs communicating in bidirectional sidelink (SL), or two BS communicating in directional backhaul. The beam correspondence of the RIS in both directions can be explained as follows. If the RIS is configured to redirect (or beam-form) the signal from a first node to a second node and the RIS can also redirect the signal from the second node to the first node with the same RIS configuration, then the RIS has beam correspondence. If the RIS cannot redirect the signal from the second node to the first node using the same RIS configuration, then the RIS does not have beam correspondence. Whether the RIS has beam correspondence or not can vary depending on RIS characteristics such as sensitivity to frequency, incident angle on the RIS, and polarization of the incident wave.

Aspects of the present application provide several different methods for configuring an RIS when a lack of beam correspondence is found when an RIS is used to redirect a signal between a transmitter and receiver.

Aspects of the present disclosure may allow the network or BS to determine whether beam-correspondence holds between the transmitter and the receiver and a particular method from one of those described below to be use when beam-correspondence does not hold. Hence, the network or BS can appropriately configure the RISs in the network.

Aspects of the present disclosure, for example use of the methods described below may improve the throughput and reliability for UL and DL communication when using a RIS.

Aspects of the present disclosure may allow for a reduction of measurements that are used for RIS that may not have a reciprocal redirection in opposite directions, i.e. UL and DL. This is because when the channel is estimated for a first direction of communication, the RIS can still perform beam sweeping for a second, opposite direction, within a range of accuracy of the channel that was determined already estimated for the first direction.

According to a first aspect of the present disclosure, there is provided a method that includes sending, by a transmitter, first configuration information to configure a reconfigurable intelligent surface (RIS) to redirect a signal over a range of directions; sending, by the transmitter, second configuration information pertaining to reference signals that are transmitted by the transmitter and redirected in a direction of a receiver by the RIS; sending, by the transmitter, the reference signals; and receiving, by the transmitter, a measurement report from the receiver identifying measurements of the reference signals performed by the receiver. When there is a lack of beam correspondence between a signal transmitted by the transmitter and redirected by the RIS in the direction of the receiver and a signal transmitted by the receiver and redirected by the RIS in a direction of the transmitter, the method further involves selecting a manner of reconfiguring the RIS to compensate for the lack of beam correspondence.

In some embodiments of the first aspect, the method further involves the transmitter determining whether there is beam correspondence or receiving an indication from the receiver or a network as to whether there is beam correspondence.

In some embodiments of the first aspect, the determining, by the transmitter, whether there is beam correspondence involves making the determination based on one or more of: a frequency resource used for transmissions made from the transmitter and a frequency resource used for transmissions made from the receiver; an angle of arrival (AoA) of a beam incident on the RIS and an angle of departure (AoD) of a beam redirected by the RIS; a difference between an AoA of a beam incident on the RIS and an AoD of a beam redirected by the RIS; accuracy of estimating an AoA and/or angle of AoD at the RIS; beam width for the incident and redirected signals at RIS; or a RIS type.

In some embodiments of the first aspect, selecting the manner of reconfiguring the RIS to compensate for the lack of beam correspondence comprises selecting the manner of reconfiguring the RIS from a group, the group involving: configuring the RIS to redirect a signal from either the transmitter or the receiver via beams that encompass an expected deviation from a desired redirection angle in bi-directional communication while the signal reaches a destination in both directions of communication with a strength that satisfies a threshold; configuring the RIS to be partitioned into two or more surface portions, wherein at least one surface portion is configured to redirect a beam from the transmitter to the receiver and a different at least one surface portion is configured to redirect a beam from the receiver to the transmitter; configuring each of a plurality of RIS, wherein at least one RIS of the plurality of RIS is configured to redirect a beam from the transmitter to the receiver and at least one RIS of the plurality of RIS is configured to redirect a beam from the receiver to the transmitter; and configuring the RIS based on time division multiplexing to allow the RIS to redirect from the transmitter to the receiver and from the receiver to the transmitter during different transmission resources.

In some embodiments of the first aspect, the method may further include one or more of: sending, by the transmitter, third configuration information to configure the RIS to redirect a signal from either the transmitter or the receiver via beams that encompass an expected deviation from a desired redirection angle; sending, by the transmitter, third configuration information to configure the RIS to partition the RIS into two or more surface portions, wherein at least one surface portion is configured to redirect a signal from the transmitter to the receiver and a different at least one surface portion is configured to redirect a signal from the receiver to the transmitter; sending, by the transmitter, third configuration information to configure each of the plurality of RISs, to redirect a signal from the transmitter to the receiver or redirect a signal from the receiver to the transmitter; sending, by the transmitter, third configuration information to configure the RIS based on time division multiplexing to redirect from the transmitter to the receiver and from the receiver to the transmitter at different transmission resources; or sending, by a transmitter, third configuration information to configure the RIS to redirect a signal from the receiver to the transmitter considering a range of directions of incident signal from the receiver to the RIS.

In some embodiments of the first aspect, the method further includes: receiving, by the transmitter, reference signals from the receiver that have been redirected by the RIS; measuring, by the transmitter, the received reference signals; and sending, by the transmitter, a measurement report to the receiver identifying measurements of the reference signals at the transmitter.

In some embodiments of the first aspect, the method further includes sending, by the transmitter, a notification that signal power of a redirected signal is reduced.

In some embodiments, the method further includes sending, by the transmitter, fourth configuration information, the four configuration information comprising timing information for different transmission recourses.

In some embodiments of the first aspect, the method further includes receiving, by the transmitter, a signal that has been redirected by the RIS via a beam that encompass an expected deviation from a desired redirection angle from the receiver with a strength that satisfies a threshold or transmitting, by the transmitter, a signal that will be redirected by the RIS to the receiver via a beam that encompass an expected deviation from a desired redirection angle to the receiver with a strength that satisfies a threshold.

In some embodiments of the first aspect, the method further includes receiving, by the transmitter, a signal that has been redirected by at least one surface portion of the RIS or transmitting, by the transmitter, a signal that will be redirected by at least one different surface portion of the RIS.

In some embodiments of the first aspect, the method further includes receiving, by the transmitter, a signal that has been redirected by at least one RIS of a plurality of RIS or transmitting, by the transmitter, a signal that will be redirected by at least one different RIS of a plurality of RIS than used for receiving a signal that has been redirected by the at least one RIS of a plurality of RIS.

In some embodiments of the first aspect, the method further includes receiving, by the transmitter, a signal that has been redirected by the RIS during a first transmission resource or transmitting, by the transmitter, a signal that will be redirected by the RIS during a second transmission resource.

According to a second aspect of the present disclosure, there is provided an apparatus that includes one or more processors and a computer-readable memory having stored thereon processor executable instructions. The processor executable instructions, when executed, perform a method according to any of embodiments described above of the first aspect.

According to a third aspect of the present disclosure, there is provided a method that includes receiving, by a reconfigurable intelligent surface (RIS), first configuration information to configure the RIS to redirect a signal over a range of directions; redirecting, by the RIS, reference signals incident on the RIS, from a transmitter, toward a receiver, the reference signals used to determine whether there is beam correspondence between a signal transmitted by the transmitter and redirected by the RIS in a direction of the receiver and a signal transmitted by the receiver and redirected by the RIS in a direction of the transmitter. When there is a lack of beam correspondence, the method further includes receiving, by the RIS, second configuration information for configuring the RIS to compensate for the lack of beam correspondence.

In some embodiments of the third aspect, the lack of beam correspondence is based on one or more of: a frequency resource used for transmissions made from the transmitter is different than a frequency resource used for transmissions made from the receiver; an AoA of a beam incident on the RIS is different than an AoD of a beam redirected by the RIS; a difference between an AoA of a beam incident on the RIS and an AoD of a beam redirected by the RIS; accuracy of estimating an AoA and/or angle of AoD at the RIS; beam width for the incident and redirected signals at RIS; or a RIS type.

In some embodiments of the third aspect, receiving, by the RIS, the second configuration information for configuring the RIS to compensate for the lack of beam correspondence includes: receiving, by the RIS, configuration information to configure the RIS to redirect a signal from either the transmitter or the receiver via beams that encompass an expected deviation from a desired redirection angle in bi-directional communication while the signal reaches a destination in both directions of communication with a strength that satisfies a threshold; receiving, by the RIS, configuration information to configure the RIS to partition the RIS into two or more surface portions, wherein at least one surface portion is configured to redirect a signal from the transmitter to the receiver and a different at least one surface portion is configured to redirect a signal from the receiver to the transmitter; receiving, by the RIS, configuration information to configure the RIS, to redirect a signal from the transmitter to the receiver or redirect a signal from the receiver to the transmitter; and receiving, by the RIS, configuration information to configure the RIS based on time division multiplexing to redirect from the transmitter to the receiver and redirect from the receiver to the transmitter in different transmission resources.

In some embodiments of the third aspect, the method further includes at least one of: configuring, by the RIS, the surface of the RIS to redirect a signal from either the transmitter or the receiver via a beam that encompass an expected deviation from a desired redirection angle; configuring, by the RIS, the surface of the RIS to partition the RIS into at least two surface portions, wherein at least one surface portion is configured to redirect a signal from the transmitter to the receiver and a different at least one surface portion is configured to redirect a signal from the receiver to the transmitter; configuring, by the RIS, the surface of the RIS to redirect a beam from the transmitter to the receiver or redirect a beam from the receiver to the transmitter; configuring, by the RIS, based on time division multiplexing to redirect from the transmitter to the receiver and redirect from the receiver to the transmitter in different transmission resources; or configuring, by a RIS, the surface of the RIS to redirect a signal from the receiver to the transmitter considering a range of directions of incident signal from the receiver to the RIS.

In some embodiments of the third aspect, the method further includes redirecting, by the RIS, reference signals sent from the receiver to the transmitter to be used by the transmitter to measure and determine an appropriate value of the angle of arrive of a beam incident on the RIS from the receiver.

According to a fourth aspect of the present disclosure, there is provided an apparatus that includes one or more processors and a computer-readable memory having stored thereon processor executable instructions. The processor executable instructions, when executed, perform a method according to any of embodiments described above of the third aspect.

According to a fifth aspect of the present disclosure, there is provided a method that includes: receiving, by a receiver, first configuration information pertaining to reference signals that will be transmitted by a transmitter and redirected in a direction of the receiver by a reconfigurable intelligent surface (RIS); receiving, by a receiver, the reference signals; sending, by the receiver, a measurement report comprising measurement information of the reference signals at the receiver. When there is a lack of beam correspondence between a signal transmitted by the transmitter and redirected by the RIS in a direction of the receiver and a signal transmitted by the receiver and redirected by the RIS in a direction of the transmitter, the method further includes receiving, by the receiver, second configuration information providing the receiver with information to configure the RIS to compensate for the lack of beam correspondence.

In some embodiments of the fifth aspect, the method further includes the receiver determining whether there is beam correspondence or receiving an indication from the transmitter or the network whether there is beam correspondence.

In some embodiments of the fifth aspect, the lack of beam correspondence is based on one or more of: a frequency resource used for transmissions made from the transmitter and a frequency resource used for transmissions made from the receiver; an AoA of a beam incident on the RIS is different than an AoD of a beam redirected by the RIS; a difference between an AoA of a beam incident on the RIS and an AoD of a beam redirected by the RIS; accuracy of estimating an AoA and/or angle of AoD at the RIS; beam width for the incident and redirected signals at RIS; or a RIS type.

In some embodiments of the fifth aspect, the method further includes receiving, by the receiver, a signal that has been redirected by the RIS via a beam that encompasses an expected deviation from a desired redirection angle from the transmitter with a strength that satisfies a threshold or transmitting, by the receiver, a signal that will be redirected by the RIS to the transmitter via a beam that encompasses an expected deviation from a desired redirection angle to the transmitter with a strength that satisfies a threshold.

In some embodiments of the fifth aspect, the method further includes receiving, by the receiver, a signal that has been redirected by at least one surface portion of the RIS or transmitting, by the receiver, a signal that will be redirected by at least one different surface portion of the RIS.

In some embodiments of the fifth aspect, the method further includes receiving, by the receiver, a signal that has been redirected by at least one RIS of a plurality of RIS or transmitting, by the receiver, a signal that will be redirected by at least one different RIS of a plurality of RIS than used for receiving a signal that has been redirected by the at least one RIS of a plurality of RIS.

In some embodiments of the fifth aspect, the method further includes receiving, by the receiver, a signal that has been redirected by the RIS during a first transmission resource or transmitting, by the receiver, a signal that will be redirected by the RIS during a second transmission resource.

In some embodiments of the fifth aspect, the receiving, by the receiver, second configuration information involves receiving, by the receiver, configuration information comprising at least one of: timing information for the first and second transmission recourses; or a guard time between the first and second transmission recourses.

In some embodiments of the fifth aspect, the method further includes sending, by the receiver, reference signals that are redirected by the RIS and receiving, by the receiver, a measurement report from the transmitter identifying measurement information of the reference signals at the transmitter.

In some embodiments of the fifth aspect, the method further includes determining a beam forming direction to send a signal that is redirected by the RIS to the transmitter, the determining based at least in part on the measurement report.

In some embodiments of the fifth aspect, the method further includes receiving, by the receiver, a notification that signal power of a redirected signal is reduced when the signal is redirected by a RIS that redirects a beam that encompass an expected deviation from a desired redirection angle from the transmitter with a strength that satisfies a threshold or a RIS that is partitioned in two surface portions.

According to a sixth aspect of the present disclosure, there is provided an apparatus that includes one or more processors and a computer-readable memory having stored thereon processor executable instructions. The processor executable instructions, when executed, perform a method according to any of embodiments described above of the fifth aspect.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a transmission channel between a source and destination in which a planar array of configurable elements is used to redirect signals according to an aspect of the disclosure.

FIG. 2A is a schematic diagram of a communication system in which embodiments of the disclosure may occur.

FIG. 2B is another schematic diagram of a communication system in which embodiments of the disclosure may occur.

FIG. 3A is a block diagram illustrating example electronic devices and network devices.

FIG. 3B is a schematic diagram of a reconfigurable intelligent surface including a planar array of configurable elements that may be used according to embodiments of the disclosure.

FIG. 3C is a block diagram illustrating units or modules in a device in which embodiments of the disclosure may occur.

FIGS. 4A, 4B and 4C illustrate examples of two way redirection between a base station and a UE via a RIS according to embodiments of the present disclosure.

FIG. 5 illustrates an example of two way redirection between a base station and a UE via a RIS in which the angle of arrival (AoA) and the angle of departure (AoD) at the RIS are not equal.

FIG. 6 illustrates an examples of two way redirection between a base station and a UE via a RIS in which the RIS redirects a beam that is wide enough to encompass an expected deviation from a desired redirection angle in bi-directional communication in each destination direction according to embodiments of the present disclosure.

FIG. 7 is an example signaling flow diagram for a method as described with regard to FIG. 6.

FIG. 8 is an example signaling flow diagram that provides further details of a portion of the signaling flow diagram of FIG. 7.

FIGS. 9A and 9B illustrate examples of two way redirection between a base station and a UE via a RIS in which the RIS is partitioned in two surface portions according to embodiments of the present disclosure.

FIG. 10 is an example signaling flow diagram for a method as described with regard to FIG. 9A.

FIG. 11 illustrates an examples of two way redirection between a base station and a UE via a RIS in which the RIS redirects a signal in a first direction for a first duration and redirects a signal in a second direction for a second duration according to embodiments of the present disclosure.

FIG. 12 is an example signaling flow diagram for a method as described with regard to FIG. 11.

FIG. 13 illustrates an examples of two way redirection between a base station and a UE via one or more RISs in which surface portions of the one or more RIS are spaced apart according to embodiments of the present disclosure.

FIG. 14 is an example signaling flow diagram for a method as described with regard to FIG. 13.

FIG. 15 illustrates an examples of two way redirection between a base station and a UE via multiple RISs in which a first RIS redirects a signal to a second RIS that redirects the signal to a destination according to embodiments of the present disclosure.

FIG. 16 is an example signaling flow diagram for a method as described with regard to FIG. 15.

### DETAILED DESCRIPTION OF ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

A Reconfigurable Intelligent Surface (RIS), also known as large intelligent surface (LIS), smart reflect-array, intelligent passive mirrors, artificial radio space, reconfigurable metasurface, holographic multiple input multiple output (MIMO) is an array of configurable elements. These configurable elements may be also known as metamaterial cells or unit cells. A metamaterial (which may also be referred to as a Beyond-Material) is a material that is engineered to change its properties in order to manipulate amplitude and/or phase of a wave incident on the metamaterial. Manipulation of the amplitude and/or phase can be achieved by changing an impedance or relative permittivity (and/or permeability) of the metamaterial. At low frequencies, the impedance is controlled through lumped elements like PIN diodes, varactors, transistors or microelectromechanical system (MEMS). At higher frequencies, the relative permittivity and/or permeability of the material element (like liquid crystal at high frequencies and graphene at even higher frequencies) changes its permittivity in accordance to changes in a bias voltage provided to the material. Consequently, the phase of the signal redirected by the material is changed in accordance with the change in permittivity. As the bias voltages involved for these materials are quite low, the materials are often referred to as passive phase shifters.

In some discussions in this disclosure, RIS devices may be referred as a set of configurable elements arranged in a linear array or a planar array. Nevertheless, the analysis and discussions are extendable to other two or three dimensional arrangements (e.g., circular array). A linear array is a vector of N configurable elements and a planar array is a matrix of N×M configurable elements. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that controls the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

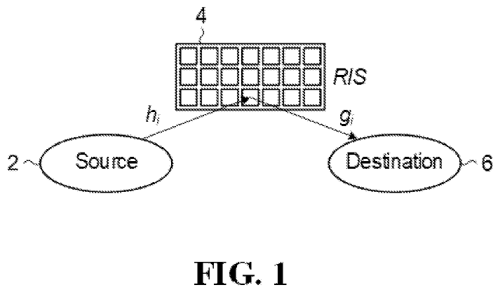

Because of their ability to manipulate the incident wave, the low cost of these types of devices, and because these types of devices require small bias voltages, RIS have recently received heightened research interest in the area of wireless communication as a valuable tool for beamforming and/or modulating communication signals. A basic example for RIS utilization in beamforming is shown in FIG. 1 where each RIS configurable element (unit cell) can change the phase of the incident wave from source such that the redirected waves from all of the RIS elements are aligned to the direction of the destination to increase or maximize its received signal strength (e.g. maximize the SNR). Such a redirection via the RIS may be referred to as reflect-array beamforming.

FIG. 1 illustrates an example of a planar array of configurable elements, labelled in the figure as RIS 4, in a channel between a source 2, or transmitter, and a destination 6, or receiver. The channel between the source 2 and destination 6 include a channel between the source 2 and RIS 4 identified as hᵢ and a channel between the RIS 4 and destination 6 identified as gᵢ for the RIS configurable element (RIS unit cell) where i∈{1,2,3, . . . , N*M} assuming the RIS consists of N*M elements or unit cells. A wave that leaves the source 2 and arrives at the RIS 4 can be said to be arriving with a particular AoA. When the wave is redirected or redirected by the RIS 4, the wave can be considered to be leaving the RIS 4 with a particular AoD.

While FIG. 1 having the two dimensional planar array RIS 4 shows a channel hᵢ and a channel gᵢ, the figure does explicitly show an elevation angle and azimuth angle of the transmission from the source 2 to RIS 4 and the elevation angle and azimuth angle of the redirected transmission from the RIS 4 to the destination 6. In the case of a linear array, there may be only one angle to be concerned about, i.e. the azimuth angle.

Assuming that the RIS has a total of N elements, each redirecting the incident wave with a phase change θᵢ, the source 2 sends a modulated symbol x, and n is the receiver noise, then the received signal y, with non-line of sight (NLOS), is:

y=Σᵢ₌₁^{N}hᵢgᵢe^{jθ}^{ᵢ}x+n

To maximize a signal-to-noise (SNR), it is intuitive to choose a phase change at each RIS element to cancel the phases due to the overall channels, which results in pure constructive superposition. It is assumed that different hᵢ have the same magnitude, and the same magnitude for different gᵢ and α and β denote the channel magnitudes. This is true for far field at high frequency propagation which is mostly dominated by line of sight (LOS) and having few paths. The resulting signal can be simplified to y=Nαβx+n. The SNR is scaled quadratically with N providing higher capacity. As will be described below, the RIS can adaptively enhance the transmission, transmit alone, or even transmit at the same time as the transmitter is sending data. Great flexibility can be afforded by using RIS-assisted communications that can make use in future systems.

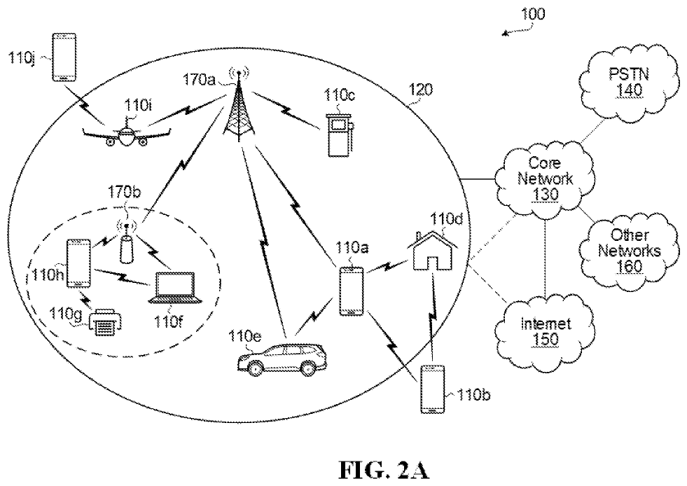

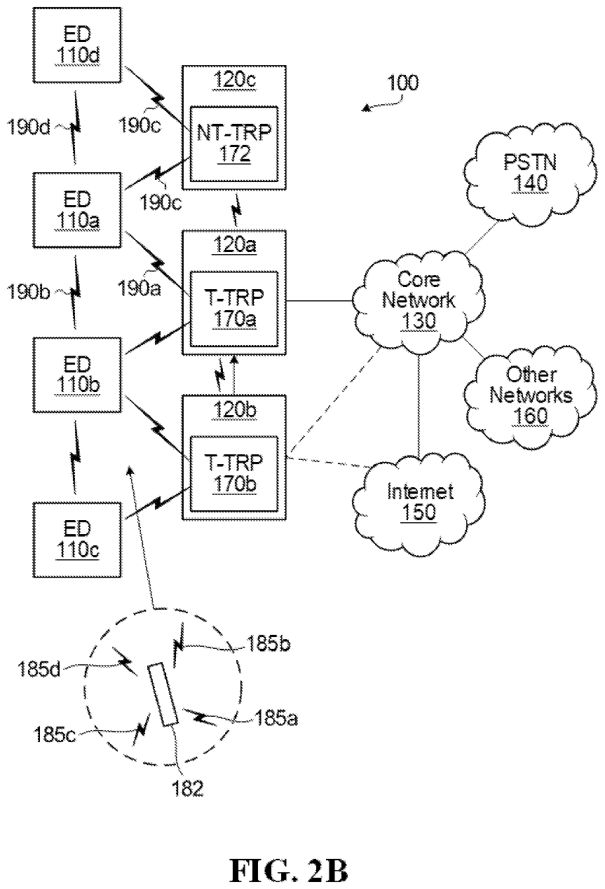

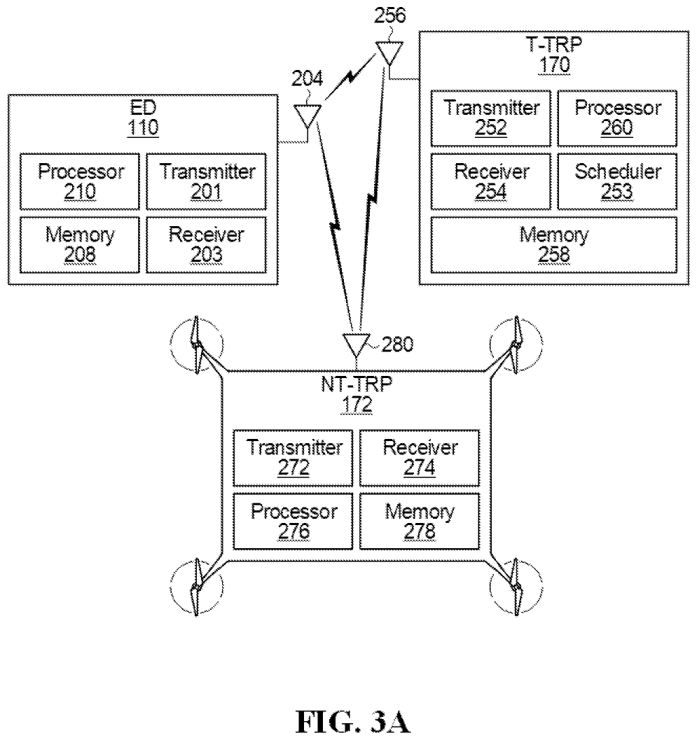

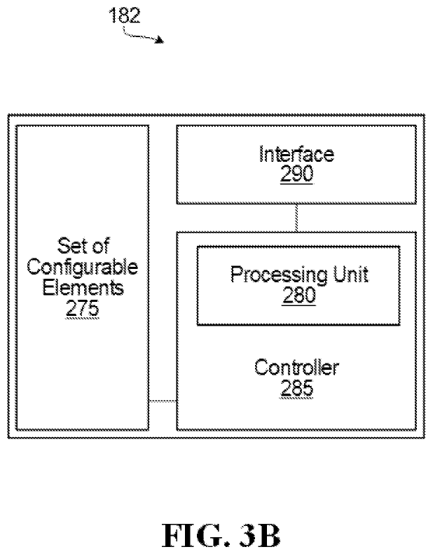

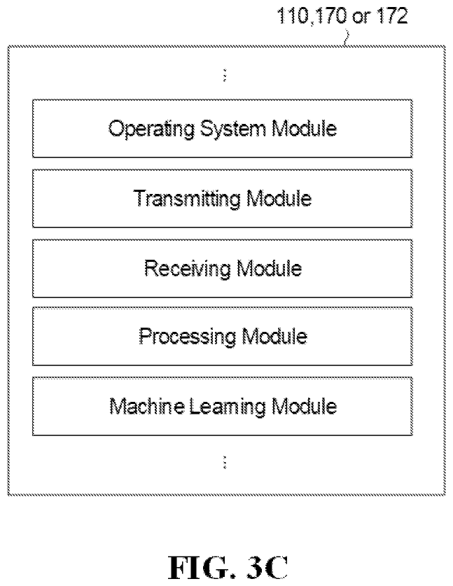

FIGS. 2A, 2B, 3A, 3B and 3C following below provide context for the network and devices that may be in the network and that may implement aspects of the present disclosure.

Referring to FIG. 2A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160. One or more RIS (not shown in FIG. 2A) could be deployed in the system 100 to facilitate communications between one and more EDs and the radio access network 120, or between EDs, or between network nodes 170 in the radio access network 120.

FIG. 2B illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered subsystems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such technologies.

The EDs 110a-110c communicate with one another over one or more SL air interfaces 180 using wireless communication links e.g. radio frequency (RF), microwave, infrared (IR), etc. The SL air interfaces 180 may utilize any suitable radio access technology, and may be substantially similar to the air interfaces 190 over which the EDs 110a-110c communication with one or more of the T-TRPs 170a-170b or NT-TRPs 172, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 180. In some embodiments, the SL air interfaces 180 may be, at least in part, implemented over unlicensed spectrum.

Also shown in FIG. 2B is an example of where an RIS 182, that is a separate node from a transmitter, may be located within a serving area of T-TRP 170b. A first signal 185a is representative of a signal from the T-TRP 170b to the RIS 182 and a second signal 185b is representative of a signal from the RIS 182 to the ED 110b, illustrating how the RIS 182 might be located within the uplink or downlink channel between the T-TRP 170b and the ED 110b. Also shown is a third signal 185c representative of a signal from the ED 110c to the RIS 182 and a fourth signal 185d is representative of a signal from the RIS 182 to the ED 110b, illustrating how the RIS 182 might be located within the SL channel between the ED 110c and the ED 110b.

While only one RIS 182 is shown in FIG. 2B, it is to be understood that any number of RIS could be included in a network.

It other embodiments, as described in further detail below, the RIS may be integrated, or collocated with, the transmitter.

FIG. 3A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2A). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

FIG. 3B illustrates an example of a RIS device that may be a separate node from the transmitter, as described in some aspects of this disclosure. In particular, FIG. 3B illustrates an example RIS 182. These components could be used in the system 100 or in any other suitable system.

As shown in FIG. 3B, the RIS 182 includes a controller 285 that includes at least one processing unit 280, an interface 290, and a set of configurable elements 275.

The processing unit 280 implements various processing operations of the RIS 182, such as receiving the configuration signal via interface 290 and providing the signal to the controller 285. The processing unit 280 could, for example, include a microprocessor, microcontroller, digital signal processor, field programmable gate array, or application specific integrated circuit.

The interface 290 enables control information for controlling the RIS or used by the RIS in the process of overlaying additional information to be received from the network, possibly via a base station in the area being served by the base station. In some embodiments the control information may be received by receive elements of the set of configurable elements and messaging can be done over the air.

While this is a particular example of an RIS, it should be understood that the RIS may take different forms and be implemented in different manner than shown in FIG. 3C. The RIS 182 ultimately needs a set of configurable elements that can be configured as described to operate herein.

While FIG. 3B shows an interface to receive configuration information from the network, if in embodiments when an antenna or a sensor were to be connected to the RIS, it may be considered a separate element from the RIS.

Additional details regarding the UEs 110 and the base stations 170 are known to those of skill in the art. As such, these details are omitted here for clarity.

One or more steps of the embodiment methods provided herein may be performed by corresponding units or modules, according to FIG. 3C. FIG. 3C illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent MCS, intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprises several framework, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data-hungry. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Aspects of the present disclosure pertain to the beam correspondence when using a RIS in a two-way redirection (TWR) scenario. TWR may include, for example, a base station (BS) and a UE communicating in uplink (UL) and downlink (DL) directions, or two UEs communicating in bidirectional sidelink (SL), or two BS communicating in directional backhaul. The beam correspondence of the RIS in both directions can be explained as follows.

The RIS comprises an array of elements that can change the phase (and also amplitude, polarization, or even the frequency) of the incident wave/signal. Such changes are achieved by configuring the RIS elements via bias voltages (or other methods like mechanical deformation and phase change materials), that are controlled by a control circuit connected to the RIS. Hence, for beamforming, RIS elements are configured to provide desired phase-shifts for the incident-waves to be redirected to a desired direction towards the destination.

Issues such as incident angle sensitivity and frequency sensitivity of the RIS, which can affect the phase-shift for each direction of communication between two nodes, need consideration in a practical implementation.

If the RIS is configured to redirect (or beam-form) the signal from a first node to a second node and the RIS can also redirect the signal from the second node to the first node with the same RIS configuration, then the RIS has beam correspondence, or it may also be referred to that the beam correspondence holds. If the RIS cannot redirect the signal from the second node to the first node using the same RIS configuration, then the RIS does not have beam correspondence or it may also be referred to that the beam corresponding does not hold. Whether the RIS has beam correspondence or not can vary depending on RIS characteristics such as sensitivity to frequency, incident angle on the RIS, and polarization of the incident wave.

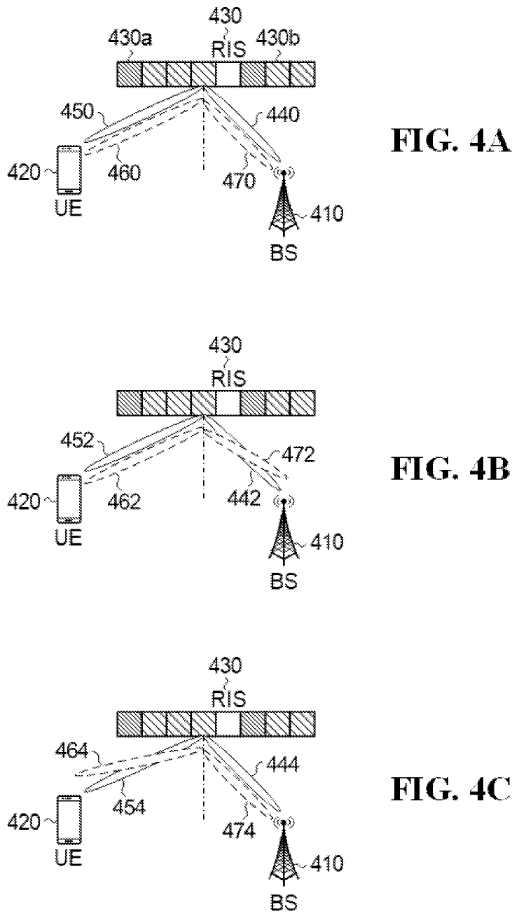

FIGS. 4A, 4B, and 4C will now be referred to in order to explain the concept of beam correspondence for a BS 410 communicating with a UE 420 via a RIS 430. In the RIS 430, each small rectangle of the RIS 430, for example 430a, and 430b is an individually addressable and configurable RIS element. In FIG. 4A, the two-way redirection involves downlink (DL) on a beam 440 from the BS 410 to the RIS 430 and a beam 450 from the RIS 430 to the UE 420 and uplink (UL) on a beam 460 from the UE 420 to the RIS 430 and a beam 470 from the RIS 430 to the BS 410. In FIG. 4A, beam correspondence holds for the two-way redirection (TWR). In such case, the RIS 430 can be configured to properly redirect the signal for one way of communication while still being sufficient for proper redirection in the other way of communication.

FIGS. 4B and 4C each include the same BS 410, UE 420 and RIS 430 as in FIG. 4A. In FIG. 4B the DL includes beams 442 and 452 and the UL includes beams 462 and 472. In FIG. 4C the DL includes beams 444 and 454 and the UL includes beams 464 and 474. FIG. 4B shows a case when the beam correspondence does not hold for TWR. In this case, while the RIS 430 is configured to redirect the signal in the DL direction (beams 442 and 452), the configuration is not appropriate for the UL direction (beams 462 and 472) and the BS 410 may not receive the signal sent by the UE 420. FIG. 4C shows another case when the beam correspondence does not hold for TWR. In this case, while the RIS 430 is configured to redirect the signal in the UL direction (beams 444 and 454), such configuration is not appropriate for the DL direction (beams 464 and 474), and the UE 420 may not receive the signal from the BS 410.

Incident angle sensitivity may be a more relevant issue for some materials (e.g. liquid crystal (LC)) than other materials that are used to implement the RIS. While LC RIS are suitable for sub-THz frequencies (e.g. 100-300 GHz) and can provide a wide range of phase-shifts, the phase shift of an LC RIS element is sensitive to the angle of the incident wave since LC is anisotropic material. Therefore, in two-way reflection using the RIS, if the angle of the incident wave from the first node to the RIS is quite different (e.g. approximately 30° difference, however the actual difference depends on specific implementation of the RIS) than that from the second node to the RIS, the RIS may not provide proper redirection in both directions of communications, even if both nodes use the same frequency, i.e., the channel is non-reciprocal.

Frequency sensitivity can cause a prism-like spreading effect of frequencies in a broad frequency band being redirected of the RIS. For a same bias voltage applied to a RIS element, beams of different frequencies may be redirected with a different amount of phase-shift. Therefore, for two-way redirection, if the first node and the second node transmit signals of different frequency (i.e. if the two node utilize frequency-division duplexing (FDD)), the RIS may not provide proper redirection in both directions, even when the angle of incidence is the same from either direction. For example, if the RIS is configured to redirect in a proper direction for the frequency used by the first node in one direction, the RIS may not redirect in a desired direction for the frequency used by the second node, without being reconfigured

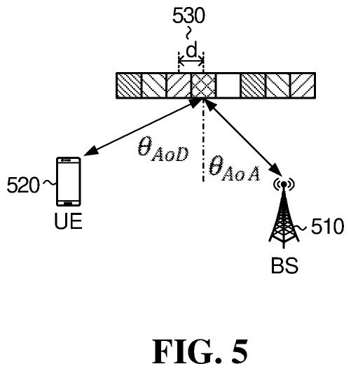

FIG. 5 illustrates another RIS 530 that redirects a signal between a BS 510 and a UE 520. The distance d is an inter-element spacing between adjacent configurable elements of the RIS 530. For a DL communication in the direction from the BS 510 to the UE 530, the angle θ_{AoD} is the angle of arrival (AoA) at the RIS 530 from the BS 510 and the angle θ_{AoD} is the angle of departure (AoD) from the RIS 530 in the direction of the UE 520. The desired phase shift at RIS elements to maximize the signal-to-noise ratio (SNR) at the receiver in one way of communication, e.g. in the DL direction from BS 510 to UE 520, where a phase-shift (ϕₙ) at the nth RIS element in a linear 1D array of multiple RIS elements satisfies the following formula:

$${ϕ}_{n} = \frac{2 π n d}{λ} ( sin {θ}_{A o D} - sin {θ}_{A o A} ) + β$$

where d is the inter-element spacing, λ is the wavelength of the transmitted signal, θ_{AoD} is the AoD from the RIS 530 to the UE 520 projected to the array direction, θ_{AoA} is the projected angle of arrival from the BS 510 to the RIS 530, and β is a constant value of the phase. The formula simply implies that a phase difference (ϕ_{d}) among two adjacent RIS elements satisfies the following formula:

$${ϕ}_{d} = \frac{2 π d}{λ} ( sin {θ}_{A o D} - sin {θ}_{A o A} )$$

The phase ϕₙ formula can be extended for a two dimensional (2D) RIS panel where the phase-shift for the (m,n) RIS element of the 2D panel satisfies the following formula:

$${ϕ}_{m , n} = \frac{2 π md}{λ} ( sin {θ}_{A o D} cos {φ}_{AoD} + sin {θ}_{AoA} cos {φ}_{AoA} ) + \frac{2 π nd}{λ} ( sin {θ}_{A o D} sin {φ}_{AoD} + sin {θ}_{AoA} sin {φ}_{AoA} )$$

where θ, φ represent the angle of arrival and departure in spherical coordinates.

The phase shifts at the RIS elements should satisfy the formulas above. With proper configuration of the RIS, e.g., via bias voltages, these phase shifts can be provided by the RIS. However, for the same configuration, the phase shifts of the RIS can be different for different frequencies and/or different incident angles. Hence, for the same configuration, the RIS phase shifts are still dependent on one or more of the following: frequency, incident angle of the wave, and polarization of the incident wave. Therefore, if the two ways of communications have different frequencies, incident angles, or both, a specific configuration for one way of communication may not be suitable for the other way of communication, i.e., beam correspondence does not hold.

The RIS are usually designed to work over specific frequency range. However, for the same configuration (e.g. bias voltage) of an RIS element, the phase shift can be different for different frequencies. For example, for a liquid crystal (LC) RIS element, the phase shift of an RIS element can be different for different applied voltages at different frequencies. As a particular example, at frequency 121.5 GHz, almost a full range of phase shift is obtained with a voltage range between 1.6 volt and 2.7 volt while other applied voltages cause almost a constant phase shift. However, at frequency 126 GHz, almost a full range of phase shift is obtained with a voltage range between 1 volt and 1.6 volt, while other applied voltages cause almost a constant phase shift. The constant phase shift not for either frequency is not helpful to make the RIS beam form the signal to a desired direction given the phase difference among two adjacent RIS elements. Therefore, if each direction of communication uses different frequencies, the RIS may not have beam correspondence because if the RIS is optimized for one direction with one frequency, the other direction with a different frequency may provide a proper directionality.

In addition to frequency sensitivity, the RIS may also be sensitive to an angle of the incident wave. Such sensitivity may stem from the materials used for implementing the RIS. At sub-THz frequencies, the RIS made from LC provides a wide-range of phase-shifts (can reach full-range of 360°) where the LC relative permittivity (ϵᵣ) changes by applying different voltages to the RIS elements, which leads to different phase-shifts of the incident wave. However, since LC is an anisotropic material, waves of different incident angles may experience different phase-shifts.

To use the RIS to provide redirection of an impinging beam, parameters of the channel at the RIS (e.g. AoA and AoD or the difference (sin θ_{AoD}−sin θ_{AoA})) are determined.

Channel parameters can be measured via several methods. For example, beam sweeping and hierarchical beamforming can be used to estimate the AoA and AoD at the RIS. Beam sweeping may involve a transmitter transmitting multiple beams in different directions and a receiver measuring the strength of the signal in one or more receive directions. In hierarchical beamforming, coarse angle estimation is carried out first via wide-beams and then, within a selected wide-beam, narrow beams are used for fine angle estimation. For a RIS with some active elements, i.e. that are capable of transmitting or receiving signals, as opposed to passive elements that redirect signals directed at the RIS, which may be connected to RF chains), the active elements can help estimate the channel independently to the UE and BS.

However, considering one or more of 1) the accuracy of AoA, AoD or (sin θ_{AoD}−sin θ_{AoA}) estimation, 2) RIS sensitivities to the frequency of the beam and/or to the angle of the incident wave, and 3) RIS phase response accuracy, the following factors be considered, especially for TWR.

When estimating the AoA and AoD at the RIS, the RIS response may be known for a subset of incident angles instead of all incident angles (e.g. a quantized incident angle). Therefore, to determine proper redirection at the RIS, one or more of the following can be used. In some embodiments, the RIS can be configured for an incident angle of unknown response considering the known responses of close incident angles. This type of solution may work if the response does not change significantly. Such decision can be made based on the measurements at the receiver or at RIS active elements. In some embodiments, beam sweeping can be performed at the RIS using approximate RIS configuration considering one or more closest AoA with a known RIS response. In some embodiments, a large RIS can be utilized where the transmitter sends a beam to different parts of the RIS such that one or more incident angles at some parts of the RIS correspond to the angles of known RIS response.

In some embodiments, when estimating the AoA and/or AoD, the estimation accuracy may determine whether the AoA and the AoD belong to a range of reciprocal response of the RIS. For example, assume the range of the AoA estimation is 8 to 12 degrees and that of the AoD estimation is 13° to 18° degrees. If the actual values from the estimate range are AoA=12° and AoD=13°, then the AoA and AoD have a reciprocal RIS response. However, if the actual values from the estimated range are AoA=8° and AoD=18°, then the AoA and AoD may not have a reciprocal RIS response and beam correspondence may not hold for TWR. If there is no beam correspondence, different solutions and/or measurements might be needed for each direction of communication.

These RIS sensitivities may affect measurements and beamforming at the RIS. Aspects of the present disclosure provide methods to address problems where there is a lack of beam correspondence, and corresponding configuration signaling to implement the methods.

In some embodiments, even if the beam correspondence holds, the RIS may need to perform another beam sweep for the other direction of communication considering different incident angles that pertain to accuracy of AoD measurements of the other direction of communication. Such further beam sweeping may help improve the SNR and provide better alignment of the redirected beams.

Some embodiments of the present disclosure may provide methods for channel estimation and/or data transmission that might be needed for each direction of communication. This is unlike the case when beam correspondence holds in which the channel-estimation for one-way of communication can be sufficient for both-ways of communication. Signaling processes between the RIS, the BS and UEs served by the BS also are provided in the embodiments of the present disclosure.

Aspects of the present disclosure provide methods that facilitate two-way redirection via the RIS when beam correspondence does not hold. In an embodiment, a wide-beam redirection via RIS may facilitate the two-way redirection when beam correspondence does not hold. The RIS may redirect the beam incident on the RIS in either direction such that the redirected beam can encompass the deviation of the redirected direction and still reach the destination. In another embodiment, RIS division may be applied. Partitioning the RIS, or using multiple different RISs, where each part, or different RIS, is configured for each direction of communication. The present disclosure also provides an embodiment that may use time division-duplexing (TDD) such that the RIS is configured to transmit in one direction at a time facilitate the two-way redirection when beam correspondence does not hold.

The following are several examples of cases when beam correspondence does not hold for TWR via RIS. While the following solutions, figures and signaling are considered for UL and DL two way communications between a BS and a UE, the methods described below can be extended for other TWR scenarios like: two UEs communicating in bidirectional sidelink (SL), or two BS communication. Moreover, while the following solutions for TWR consider DL measurements first and then UL measurements, similar solutions are applicable for the reverse order is also possible, i.e., consider UL measurements and then DL measurements when beam correspondence does not hold.

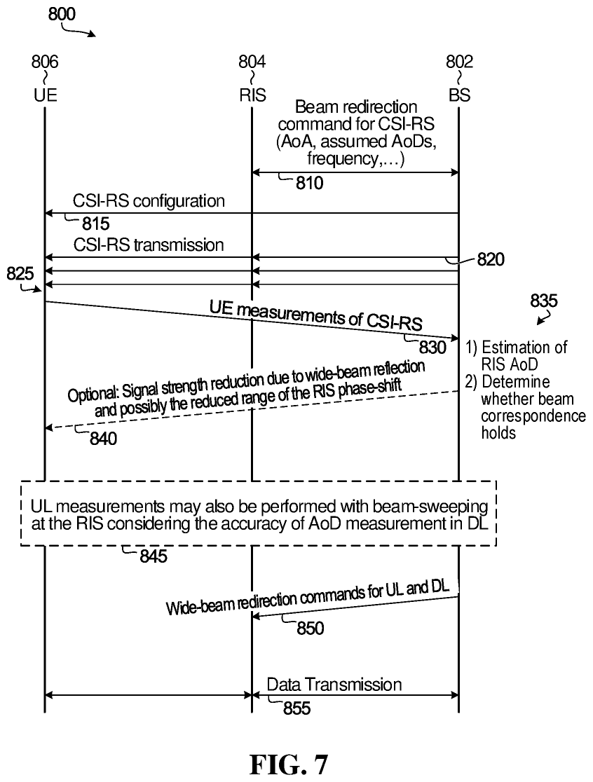

FIGS. 7, 10, 12, 14 and 16 show different examples of methods for configuring the RIS to compensate when there is a lack beam correspondence. For example, the BS, or a different device in the network, may be able to select a method to compensate for the lack beam correspondence from the various examples described below.

As shown in FIGS. 4B and 4C, when the RIS is configured the same for both directions of communication, RIS redirection is not appropriate in one direction, causing the beam to deviate from a direction of the desired destination. One manner of addressing this problem is to configure the RIS to redirect the signal using beams that are wide enough to encompass an expected deviation from a desired redirection angle and still be received at the desired destination with a signal strength that meets a threshold. In this manner, the signals in both directions will reach the destination, even if they deviate from the exact direction.

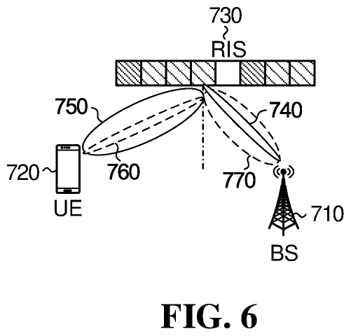

FIG. 6 shows another arrangement of BS 710, UE 720 and RIS 730. A signal on beam 740 is transmitted from the BS 710 and the redirected beam 750 from the RIS 730 is wide enough to be received at the UE 720. A signal on beam 760 is transmitted from the UE 720 and the redirected beam 770 from the RIS 730 is wide enough to be received at the BS 710. The BS 710 and UE 720 beamform their respective transmitted signals to the RIS 730 and the RIS 730 redirects these signals via wide beams.

In this example, from UE perspective, UL beam 760 and DL beam 750 point in the same direction although beam correspondence does not hold. RIS redirection via the wider beams help the UE 720 and BS 710 receive signals transmitted from the BS 710 and UE 720, respectively.

In some embodiments, due to the beam being spread over an area wide enough to encompass the destination node, the strength of the received signal may be reduced. This reduction may be acceptable as long as the received signal strength satisfies a certain threshold in order to meet a specific service requirement. In some embodiments, further reduction may occur in one direction of communication that has an incident angle at the RIS with a lower range of phase shift.

Signaling for the embodiment described above for a beam redirection wide enough to encompass the destination node will now be explained with help of FIG. 7 for downlink channel estimation and/or data transmission. FIG. 7 shows a signaling flow diagram 800 for downlink channel estimation and data transmission involving a base station (BS) 802, planar array (labelled as RIS) 804 and UE 806. These are all elements that are part of a network, but there are also other components in the network that may perform functionality that controls how the network operates. For example, the network may provide configuration information to the planar array directly via a wired or wireless connection or the network may provide configuration information to the planar array via the base station. It should be understood that while FIG. 7 is directed to downlink channel estimation and data transmission, similar principles could be applied to implement an uplink channel estimation and data transmission.

The BS 802 may obtain the type of the RIS that is being used in the channel. For example, lumped elements like PIN diodes, varactors, transistors or MEMS at low frequency, liquid crystal at high frequencies and graphene at even higher frequencies. The type may refer to particular characteristics as well, such as a relation between the bias voltage, phase shift and frequency. In some embodiments, the type may be identified to the base station or notified by the network before the events shown in FIG. 7. In some embodiments, the type of the RIS might be part of configuration information sent to the base station by the RIS in step 810.

If the network knows the BS 802 and RIS 804 locations, the BS 802 can beamform a transmission signal to the RIS 804 and configure the RIS 804 to redirect to different directions (i.e. different AoDs) to enable the BS 802 to determine a configuration of the RIS with a strongest signal received at the UE 806, once the BS 802 has received measurement information from the UE 806 for the signals redirected in the different directions. In some embodiments, it is also possible that the BS 802 does not know exactly the direction of the RIS 804. In this case, the BS 802 may also perform beam sweeping and the RIS 804 is configured to redirect to different directions assuming different incident angles (i.e. AoA from BS to RIS).

The BS 802 sends 810 RIS configuration information (e.g., possibly in the form of a beam redirection command) to the RIS 804. The RIS configuration information notifies the RIS 804 that the BS 802 will be transmitting a reference signal, in this example CSI-RS, in the direction of the RIS 804 that the RIS 804 will redirect to the UE 806. This RIS configuration information helps the RIS 804 generate a hologram, which is the control information that drives the configurable elements of the RIS 804. This hologram may a set of bias voltages for the configurable elements of the RIS 804. The RIS configuration information may also include one or more of the following:
a) the carrier frequencies of the reference signals;
b) a difference of the phase shifts between adjacent planar array elements;
c) one or more AoD as the RIS will redirect the reference signals to different assumed direction;
d) more than one AoA can be also assumed when the network or BS does not know the AoA the transmitter to the RIS;
e) the beam width of the redirected signal; and
f) identification of which surface portions of the planar array are configured to redirect respective reference signals.

In some embodiments, the RIS configuration information may be sent by the BS 802 as higher layer signaling between the BS 802 and RIS 804. The higher layer signaling may use existing higher layer signaling such as radio resource control (RRC) signaling or may use a signaling designed for this type of communication between the BS 802 and RIS 804. In some embodiments, the RIS 804 may be connected to the BS 802 through a wireless communication link in the same band and radio access technology (RAT) as the BS 802 and the UE 806. In some embodiments, the RIS 804 may be connected to the BS 802 through a separate wired or wireless medium.

In some embodiments, the RIS configuration information may use media access control-control element (MAC-CE) signaling or other signaling mechanism. Such a signaling mechanism may look like Xn signaling, which is signaling used for BS communications.

While the BS 802 is shown sending the RIS configuration information, as mentioned above, the RIS configuration information may be provided to the RIS 804 by a network device other than the base station, via a wired and/or wireless connection. Furthermore, in some embodiments (e.g. RIS has some active elements), the RIS may send some feedback to the BS or network (e.g. RIS sends some measurements for AoA estimate (e.g. coarse estimate) from BS to RIS). Also, as mentioned above, the network (when connected to the RIS 804) may notify the BS 802 about the RIS configuration information that has been provided by the network to the RIS. These various examples are captured by the bidirectional arrow of 810.

The BS 802 sends 815, to the UE 806, reference signal configuration information regarding the reference signals, for example, CSI-RS. The BS 802 may also send the carrier frequencies of the reference signals for multiple narrow signals or wideband signals to the UE 806. In some embodiments, the reference signal configuration information may also include an identification that the RIS 804 is in the path of the communication channel because the measurement and feedback process for the channel estimation are different than if the RIS 804 is not in the path. In some embodiments, the reference signal configuration information may be sent by the BS 802 as higher layer signaling between the BS 802 and UE 806. The higher layer signaling may use existing higher layer signaling such as RRC signaling or may use a signaling designed for this type of communication between the BS 802 and UE 806. In some embodiments, the configuration information may be sent using MAC-CE signaling.

While steps 810 and 815 are shown in a particular order, it should be understood that the order may be reversed.

The BS 802 sends 820 the reference signals, which are redirected to the UE 806 by the RIS 804 based on the RIS configuration information sent by the BS 802 in step 810. While three separate transmissions are shown in the signaling flow diagram of FIG. 7, one for each of three RIS redirection configurations, it is to be understood that the reference signal transmissions may be simultaneous or at separate times. Furthermore, while three signals are shown being transmitted in FIG. 7, this is merely an example and there may be more or less than three signals being transmitted. The different reference signals (e.g. CSI-RS) will be redirected in different directions by the RIS 804.

The UE 806 measures 825 the redirected reference signals and the UE 806 then transmits 830 measurement feedback information to the BS 802 and/or toward the RIS 804 so that the RIS 804 would redirect the measurement feedback information to the BS 802. The UE 806 may be performing measurements (e.g. RSRP, SNR, RSSI, etc.) of the received reference signals selected by the BS while beam sweeping. For example, the UE 806 performs a measurement in a given direction and then a measurement in another direction and then a further measurement in yet another direction. For narrow band reference signals, the UE 806 measures the reference signals and feeds back information to the BS 802. For wide-band reference signals, the UE 806 measures the frequency response and feeds it back to the BS 802. In the scenario of wideband reference signals, the channel between the BS 802 and UE 806 when the RIS 804 is being used will appear similar to a multipath fading channel, which is different than a regular THz channel that comprises mainly few distinguishable paths (e.g. a line of sight (LOS) path and one or two other paths). The UE 806 may measure the RSRP or the RSSI of two or more of the reference signals or the ratio of two RSRP or the RSSI. In some embodiments, the UE 806 feeds back an index of one or more CSI-RS with strong measurements that meet a specific threshold (e.g., SNR is greater or equal a specific value). The UE 806 sends 830 the measurement feedback information to the BS 802 via different methods including, but not limited to, the following:
1) a direct link that was previously known between the UE 806 and BS 802 and that has acceptable quality;
2) a redirected link via the RIS 804, which is known from a previous “connection” to be of acceptable quality;
3) a direct link to the base station 802 on a different frequency band, such as a microwave band; and
4) different RAT mechanisms like Bluetooth or Zigbee.

In some embodiments, the measurement feedback information may be physical layer signaling carried over physical uplink control channel (PUCCH), physical uplink shared channel (PUSCH), or another type of uplink signaling channel.

The BS 802 receives the information sent from the UE 806 and performs processing 835 to estimate the channel. This may include the BS 802 determining an estimate of the AoD for the reference signal at the RIS 804 based on the received information. This may enable a determination of whether there is beam correspondence between the BS 802 and the UE 806 based on a particular configuration of the RIS. This may include the BS 802 determining, based on the signal measurements received from the UE 806, the portion of the configurable element that redirects the reference signals of a given frequency in the given direction. The BS 802 can then determine, based on the frequency that will be used to transmit data to the UE 806 via the RIS 804, the configuration information that is to be transmitted to the RIS 804 to result in a desired AoD from the RIS 804 that has a beamwidth that is wide enough so that the signal is received at the UE 806 from DL and so that an UL signal sent by the UE 806 will be received at the BS 802. The estimate of the channel, which may include, but is not limited to, the desired AoD from the RIS for a data transmission to be transmitted by the base station and redirected by the RIS for a particular carrier frequency may generally be referred to as channel information. From these measurements, the BS 802 estimates the desired AoD from the RIS 804 to the UE 806. Note that such AoD can be considered as AoA for UL direction of communication. In some embodiments, based on the DL frequency and possibly the UL frequency, AoA and AoD at the RIS 804, the BS 802 determines whether beam correspondence holds. If not, the base station sends configuration commands to the RIS 804 to redirect via wide beam for data transmission.

The determining whether there is beam correspondence may be based on one or more factors such as, but not limited to: a frequency resource used for transmissions made from the transmitter and a frequency resource used for transmissions made from the receiver; an angle of arrival of a beam incident on the RIS and an angle of departure of a beam redirected by the RIS; a difference between an angle of arrival of a beam incident on the RIS and an angle of departure of a beam redirected by the RIS; accuracy of estimating AoA/AoD at the RIS; beam width for the incident and redirected signals at RIS; and a RIS type.

With regard to the factor of accuracy of estimating AoA/AoD at the RIS, in some embodiments, the AoD from the RIS to the receiver may be estimated with some error for one-way of communication. This error may lead to improper RIS redirection in the other way of communication. With regard to the factor of beam width for the incident and redirected signals at RIS, in some embodiments, as the beams get wider, the two-way communication via the RIS may be possible even if the RIS redirection is not identical in both directions of communication.

The BS 802 then may optionally send 840 an indication that there is a signal strength reduction due to the beam being wide enough to encompass the destination. It is possible to compensate for a power reduction or an SNR reduction by increasing the transmission power. In some embodiments, if the UE sends its SNR threshold to the BS, the BS may not need to inform the UE about the SNR reduction as long as the SNR satisfies a threshold at the receiver. In some embodiments, the indication may be sent by the BS 802 as higher layer signaling between the BS 802 and UE 806. The higher layer signaling may use existing higher layer signaling such as RRC signaling or may use a new signaling designed for this type of communication between the BS 802 and RIS 804. In some embodiments, the BS 802 may send the indication to the UE 806 using MAC-CE signaling.

In some embodiments, the indication sent 840 may include an indication that there is a reduced range of possible RIS phase-shift available.

Also optionally, UL measurements may be performed at step 845 with beam sweeping at the RIS depending on the accuracy of the AoD measurements in DL. In some embodiments, the UE may send a different type of RS (for example sounding reference signals (S-RS)) to the RIS when the RIS is configured to redirect to the BS with a different set of incident angles that pertain to the accuracy of AoD estimation in DL and/or knowledge of the RIS response at that incident angle. When beam correspondence does not hold, and wide beam redirection is carried out at the RIS, such a step is optional. Even if the AoD is not quite accurate, the redirected beam may still reach the BS due to wide beam redirection. However, if the beam correspondence is determined to hold at decision step 835 and wider beam redirection is not needed, additional beam sweeping by the UE may still be used and as a result, improve the gain.

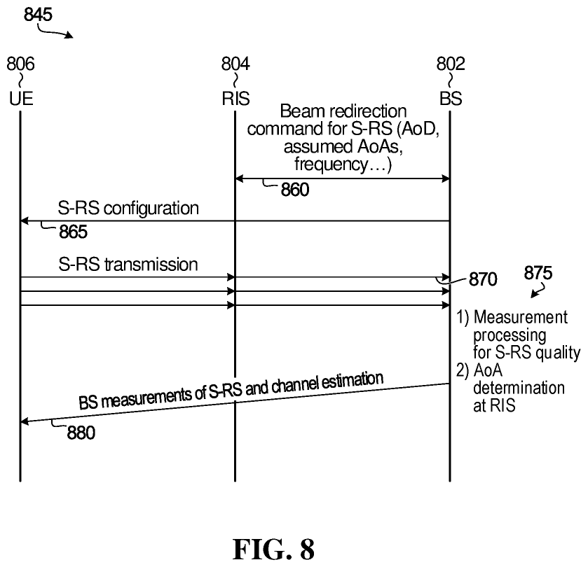

FIG. 8 illustrates a more detailed example of what may occur in step 845 of FIG. 7 and a similar step described in some of the examples below.

The BS 802 sends 860 RIS configuration information (e.g., possibly in the form of a beam redirection command) to the RIS 804. The RIS configuration information notifies the RIS 804 that the UE 806 will be transmitting a reference signal, in this example S-RS, in the direction of the RIS 804 that the RIS 804 will redirect to the BS 802. This RIS configuration information helps the RIS 804 generate a hologram, which is the control information that drives the configurable elements of the RIS 804. This hologram may a set of bias voltages for the configurable elements of the RIS 804. The RIS configuration information may also include one or more of the following:
a) the carrier frequencies of the reference signals;
b) a difference of the phase shifts between adjacent planar array elements;
c) one or more AoD from RIS;
d) one or more AoA to RIS;
e) the beam width of the redirected signal; and
f) identification of which surface portions of the planar array are configured to redirect respective reference signals.

In some embodiments, the RIS configuration information may be sent by the BS 802 as higher layer signaling between the BS 802 and RIS 804. The higher layer signaling may use existing higher layer signaling such as RRC signaling or may use a new signaling designed for this type of communication between the BS 802 and RIS 804. In some embodiments, the RIS 804 may be connected to the BS 802 through a wireless communication link in the same band and RAT as the BS 802 and the UE 806. In some embodiments, the RIS 804 may be connected to the BS 802 through a separate wired or wireless medium.

In some embodiments, the RIS configuration information may use MAC-CE signaling or other signaling mechanism. Such a signaling mechanism may look like Xn signaling, which is signaling used for BS communications.

While the BS 802 is shown sending the RIS configuration information, as mentioned above, the RIS configuration information may be provided to the RIS 804 by a network device other than the base station, via a wired and/or wireless connection. Also, as mentioned above, the network (when connected to the RIS 804) may notify the BS 802 about the RIS configuration information that has been provided by the network to the RIS, as suggested by the bidirectional arrow of 860.

The BS 802 sends 865, to the UE 806, reference signal configuration information regarding the reference signals and the carrier frequencies of the reference signals for multiple narrow signals or wideband signals that the UE should be transmitting. In some embodiments, the reference signal configuration information may also include an identification that the RIS 804 is in the path of the communication channel because the measurement and feedback process for the channel estimation are different than if the RIS 804 is not in the path. In some embodiments, the reference signal configuration information may be sent by the BS 802 as higher layer signaling between the BS 802 and UE 806. The higher layer signaling may use existing higher layer signaling such as RRC signaling or may use a new signaling designed for this type of communication between the BS 802 and UE 806. In some embodiments, the configuration information may be sent using MAC-CE signaling.

While steps 860 and 865 are shown in a particular order, it should be understood that the order may be reversed.

The UE 806 sends 870 the reference signals, which are redirected to the BS 802 by the RIS 804. While three separate transmissions are shown in the signaling flow diagram of FIG. 8, it is to be understood that the reference signal transmissions may be simultaneous or at separate times. Furthermore, while three signals are shown being transmitted in FIG. 8, this is merely an example and there may be more or less than three signals being transmitted. The different reference signals (e.g. S-RS) will be redirected in different directions by the RIS 804.

The BS 802 measures 875 the redirected reference signals and the BS 802 then transmits 880 measurement feedback information to the UE 806 and/or toward the RIS 804 so that the RIS 804 would redirect the measurement feedback information to the UE 806. The BS 802 may be performing measurements (e.g. RSRP, SNR, RSSI, etc.) of the received S-RS signals selected while beam sweeping. For example, the BS 802 performs a measurement in a given direction and then a measurement in another direction and then a further measurement in yet another direction. For narrow band reference signals, the BS 802 measures the reference signals and feeds back information to the UE 806. For wide-band reference signals, the BS 802 measures the frequency response and feeds it back to the UE 806. In the scenario of wideband reference signals, the channel between the BS 802 and UE 806 when the RIS 804 is being used will appear similar to a multipath fading channel, which is different than a regular THz channel that comprises mainly few distinguishable paths (e.g. a LOS path and one or two other paths). The BS 802 may measure the RSRP or the RSSI of two or more of the reference signals or the ratio of two RSRP or the RSSI. In some embodiments, the BS 802 feeds back an index of one or more CSI-RS with strong measurements that meet a specific threshold (e.g., SNR is greater or equal a specific value). The BS 802 sends 880 the measurement feedback information to the UE 806 via different methods including, but not limited to, the following:
1) a direct link that was previously known between the UE 806 and BS 802 and that has acceptable quality;
2) a redirected link via the RIS 804, which is known from a previous “connection” to be of acceptable quality;
3) a direct link to the base station 802 on a different frequency band, such as a microwave band; and
4) different RAT mechanisms like Bluetooth or Zigbee.

In some embodiments, the measurement feedback information may be physical layer signaling carried over PDCCH, PDSCH, or another downlink signaling channel.

The BS 802 then may send 850 RIS configuration information to the RIS 804 (e.g. possibly in the form of a wide beam redirection comments) to configure the RIS for a beam being wide enough to encompass the destination for two way redirection based upon the measurement feedback information received from the UE 806 and frequency information of the UL and DL signals. The RIS 804 generates a hologram that includes the bias control information based on the configuration information received from the base station 802. In some embodiments, the RIS configuration information may be sent by the BS 802 as higher layer signaling between the BS 802 and RIS 804. The higher layer signaling may use existing higher layer signaling such as RRC signaling or may use a new signaling designed for this type of communication between the BS 802 and RIS 804. In some embodiments, the BS 802 may send the indication to the RIS 804 using MAC-CE signaling.

In some embodiments, the BS 802 may also inform the UE 806 about the new beam width or more specifically, the signal strength reduction due to widening the beam. The UE 806 may need such information to determine whether such signal strength meets its service requirement. If not, the UE 806 may inform the BS 802, which can alleviate such reduction by other methods like increasing the transmit power. For example, the UE 806 may increase transmit power in UL while the BS 802 may increase transmit power in DL.

The BS 802 and the UE 806 transmit and receive 855 data over the channel via the RIS 804. The BS 802 can use a particular waveform, e.g., orthogonal frequency division multiplexed (OFDM) transmission with a particular subcarrier spacing to mitigate the multipath fading of the channel.

While FIG. 7 shows an example of a signaling flow diagram applicable for DL, a wider beam redirection to maintain beam correspondence can be used for UL as well.

In some embodiments, the RIS creates a wider beam width for the redirected beam by utilizing knowledge of the RIS response and AoA/AoD, when known. Furthermore, wide beam sweeping may be used if the if the AoA/AoD are not known with desired accuracy.

In some embodiments, the wider beam being redirected by the RIS allows the UE to maintain beam correspondence in DL and UL at the UE side in DL. In some embodiments, the beam being redirected by the RIS being wide enough to encompass the destination may result in the UE having to use a higher UL transmit power. In some embodiments, the wider beam being redirected by the RIS may result in a lower spectral efficiency in both UL and DL directions due to a reduced overall channel gain.

While numbered differently in FIGS. 6 and 7, is should be understood that BS 710 and BS 802 are the same, or a similar type of device, with similar capabilities. The same applies to UE 720 and UE 806 and RIS 730 and RIS 804.

In some embodiments, a surface of an RIS may be partitioned into multiple portions, for example, two portions and a first portion of the RIS is configured to redirect a DL beam in a desired direction toward the UE and a second portion of the RIS is configured to redirect an UL beam in a desired direction toward the BS. However, since each portion of the RIS receives the beam for a DL transmission scenario or for a UL transmission scenario, while one portion of the RIS is configured to redirect in the correct direction i.e. the first portion for DL, the second portion for UL, the other portion i.e. the second portion for DL, the first portion for UL, redirects the transmitted beam in an undesired direction. In some embodiments, the RIS may be partitioned into more than two portions such that there are 1) one or more portions for UL, and 2) one or more portions for DL.

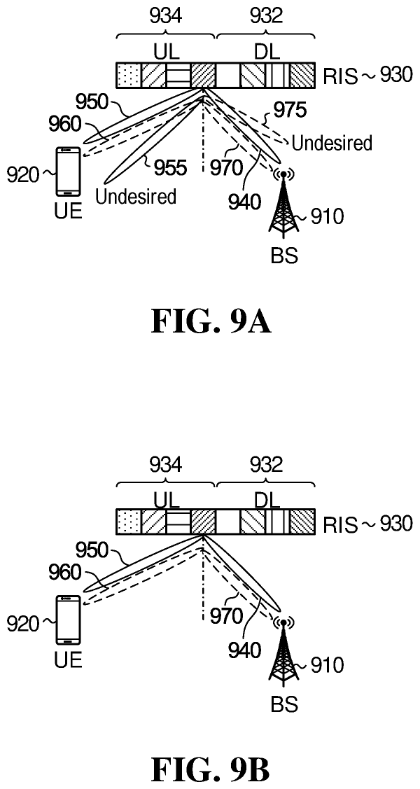

FIG. 9A shows an arrangement of BS 910, UE 920 and RIS 930. The surface of the RIS 930 is partitioned in two portions. The first portion 932 is configured to redirect the DL beam from the BS 910 to the UE 920 and the second portion 934 is configured to redirect the UL beam from the UE 920 to the BS 910. A beam 940 is transmitted from the BS 910 and there are two redirected beams 950 and 955 from the RIS 930. Beam 950 is generally in the direction of the UE 920 and beam 955 is in an undesired direction. A beam 960 is transmitted from the UE 920 and there are two redirected beams 970 and 975 from the RIS 930. Beam 970 is generally in the direction of the BS 910 and beam 975 is in an undesired direction.

In some embodiments, by selecting different frequencies for UL and DL it may be possible to avoid a beam being redirected in the undesirable direction. As described above, the RIS may be susceptible to frequency sensitivity. Therefore, careful selection of the frequencies for DL and UL may enable that the DL beam at a first frequency is redirected by the first portion in the direction of the UE. Likewise, the UL beam at a second frequency is redirected by the second portion in the direction of the BS.

FIG. 9B illustrates an example of only a single beam 950 being redirected by the RIS 930 because the first portion 932 is configured to redirect the DL beam having a first frequency signal and the second portion 934 is configured to redirect the UL beam having a second frequency signal. There may still be a reduction in beam strength because only a portion of the RIS 930 is redirecting in the desired direction toward the intended destination.

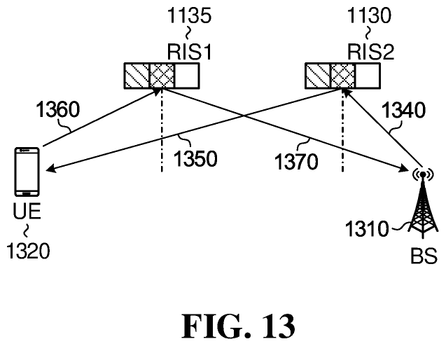

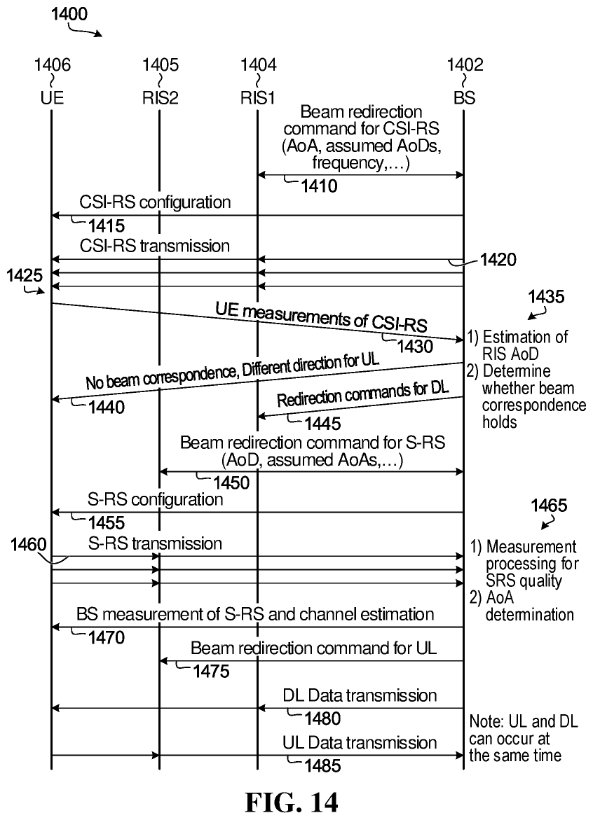

While FIGS. 9A and 9B are shown to include two surface portions, it is to be understood that the RIS could be subdivided into more than two portions. In addition, the portions do not need to be immediately adjacent to one another. However, if the portions become spaced apart far enough, the scenario would then begin to resemble embodiments described below with regard to FIGS. 13 and 14.

In some embodiments, as opposed to using a single RIS for which a surface is partitioned into two portions, two separate RISs can be used. In some embodiments, the two RIS may be separate portions of a large RIS, which is described in further detail below. In some embodiments, as opposed to using only a single RIS that is partitioned into more than two portions, multiple separate RISs can be used (e.g. at least one RIS for UL and at least one RIS for DL). Moreover, these separate RISs may be separate portions of a large RIS.

When the RIS is in the near field of UE, different beams may be needed for UL and DL. The near field is a distance less than the Fraunhofer distance, which is given by

$${d}_{F} = \frac{2 {D}^{2}}{λ}$$

from the source of a diffracting edge or antenna of diameter D. Considering both of the UE and the RIS, D is a maximum of the dimension of UE antenna panel and the dimension of the RIS panel. The direction for UE UL and DL beams can be measured via 1) separate beam sweeping for UL and DL or 2) the knowledge of RIS size and UE location.

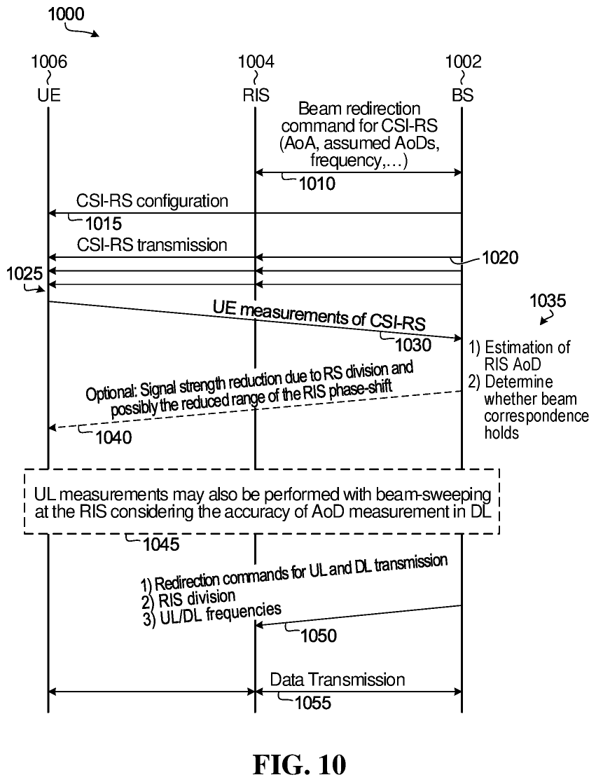

The signaling for embodiments having a partitioned RIS shares some similarity to that of the wider beam embodiments as described with reference to FIG. 8. FIG. 10 is an example of a signaling flow diagram for a partitioned RIS, where steps 1010, 1015, 1020, 1025, 1030, 1035, and 1040 are the same as steps 810, 815, 820, 825, 830, 835, and 840 in FIG. 7. Initially the BS 1002 sends configuration information to the UE 1006 for identifying a reference signal, in the example of FIG. 10 that being CSI-RS, via the RIS 1004. If no beam correspondence is found when using the initial configuration of RIS 1004, the BS 1002 then communicates with the RIS 1004 and the UE 1006 to configure the partitioned approach as described in further detail below.

After the BS 1002 has determined there is no beam correspondence, at step 1035 and may optionally send an indication to the UE at step 1040 indicating a reduction in signal power may occur due to the partitioned RIS. It is possible to compensate for a power reduction or an SNR reduction by increasing the transmission power. In some embodiments, if the UE 1006 sends a SNR threshold value to the BS 1002, the BS 1002 may not need to inform the UE 1006 about the SNR reduction as long as the SNR satisfies a threshold at the receiver. In some embodiments, the indication may be sent by the BS 1002 as higher layer signaling between the BS 1002 and UE 1006. The higher layer signaling may use existing higher layer signaling such as RRC signaling or may use a new signaling designed for this type of communication between the BS 1002 and UE 1006. In some embodiments, the BS 1002 may send the indication to the UE 1006 using MAC-CE signaling.

Also similar to step 845 in FIG. 7, at step 1045 the portion of the RIS 1004 configured for UL can be configured to redirect to the BS 1002 assuming different incident angles related to the accuracy of AoD estimation in DL.

At step 1050, the BS 1002 may send RIS configuration information to configure the RIS 1004 (i.e. possibly in the form of a redirection command) to be divided to two parts where each part is configured to performs redirection for a particular direction, either DL or UL. The RIS configuration information may include information such as the size of respective partitioned surface portions and information regarding how the respective portions should be configured. The information regarding how the respective surface portions should be configured may include one or more of: frequency information of the signals (i.e. UL and DL frequencies), AoA and AoD information, phase difference, beam-width and any other redirecting configuration information that could be used to configure the RIS for redirection. In some embodiments, the RIS configuration information may be sent by the BS 1002 as higher layer signaling between the BS 1002 and RIS 1004. The higher layer signaling may use existing higher layer signaling such as RRC signaling or may use a new signaling designed for this type of communication between the BS 1002 and RIS 1004. In some embodiments, the BS 1002 may send the indication to the RIS 1004 using MAC-CE signaling.

The base station 1002 and the UE 1006 transmit and receive 1055 data over the channel via the RIS 1004 as configured in 1045 and 1050.

In some embodiments, the partitioned RIS allows the RIS to perform a different beamforming for each configured surface portion of the RIS by using the RIS response and AoA/AoD values, when AoA/AoD are known. In some embodiments, the partitioned RIS allows the RIS to perform a different beamforming for each configured surface portion of the RIS by using narrow beam sweeping if AoA/AoD are not known with required accuracy.

In some embodiments, at the UE, the partitioned RIS allows different beams in the DL direction and the UL direction when the RIS is in the near field in which the angular separation of the two parts is comparable to, or larger than, the beam width at the UE side. In some embodiments, at the UE, the beam correspondence is maintained in the DL direction and the UL direction when the RIS is in the far field defined as when the angle separation of the two parts is much smaller than the beam width at the UE side.

In some embodiments when the RIS is in the near field and the RIS is partitioned into, for example, two surface portions, the beam separation at the UE for UL and DL may be determined through 1) beam sweeping or 2) a combination of the knowledge of the UE-RIS distance, RIS size and portion to be used for redirecting in a given direction, i.e. UL or DL. Once the angle for one direction is determined the angle for the other direction can also be easily determined because of operating in the near field, knowing the other portion is for the other direction and knowing the size of the RIS.

In some embodiments, the partitioned RIS may result in the UE having to use a higher UL transmit power. In some embodiments, the wider beam being redirected by the RIS may result in a lower spectral efficiency in both UL and DL directions due to a reduced overall channel gain.

While numbered differently in FIGS. 9A, 9B and 10, it should be understood that BS 910 and BS 1002 are the same, or a similar type of device, with similar capabilities. The same applies to UE 920 and UE 1006 and RIS 930 and RIS 1004.

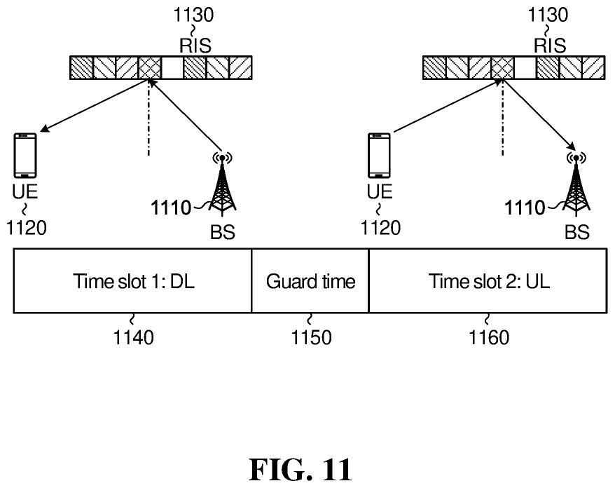

In some embodiments, a time division duplexing (TDD) arrangement is utilized as shown in FIG. 11. FIG. 11 shows two time slots, Time slot 1 1140 used for DL transmission and Time slot 2 1160 used for UL transmission, separated by a guard time 1150. FIG. 11 also includes schematic diagrams of BS 1110, UE 1120 and RIS 1130 showing beam transmission for respective DL and UL directions.

In such embodiments, the RIS 1130 is configured for one direction of communication (e.g. DL) for a portion of time, i.e. Time Slot 1 1140. Then, the RIS 1130 is reconfigured to redirect for the other direction of communication (e.g. UL) at a different time, i.e. Time Slot 2 1160. Referring to FIG. 11, during Time Slot 1 1140 the RIS 1130 is configured to redirect the DL beam from the BS 1110 to the UE 1120 and during Time Slot 2 1160 the RIS 1130 is configured to redirect the UL beam from the UE 1120 to the BS 1110. However, because some RISs have a long response time (especially those made of LC where response times can be in terms of ms), a guard time may be used between different communication directions (DL and UL) to allow proper reconfiguration of the RIS. FIG. 11 shows a guard time 1150 between the first time duration 1140 and the second time duration 1160. For fast RIS, guard times can be reduced in length. If the response time is longer in time, the BS may utilize the guard time to communicate with other UEs or nodes. In some embodiments, the TDD arrangement may include utilizing multiple time slots such that there are 1) one or more time slots for UL, 2) one or more time slots for DL, and 3) one or more slots for guard times.

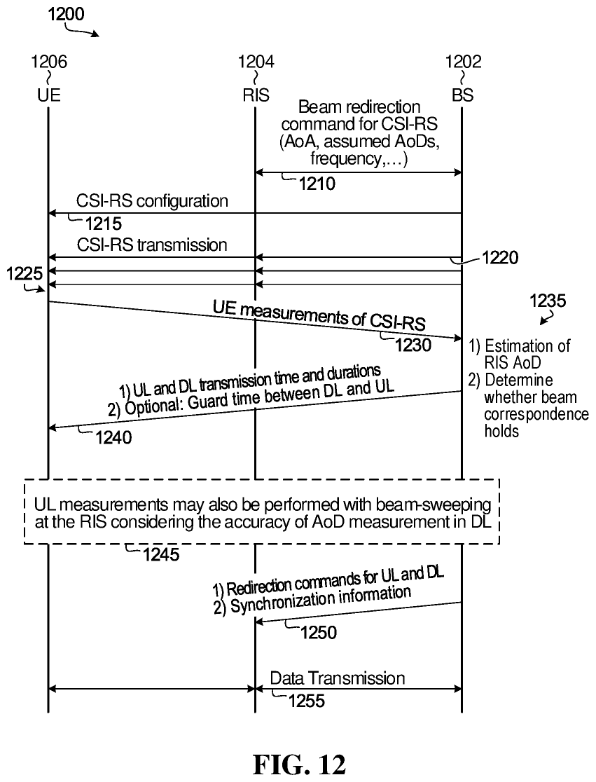

The signaling for embodiments using time division duplexing shares some similarity to that of the wider beam embodiments as described with reference to FIG. 7. FIG. 12 is an example of a signaling flow diagram for a time division duplex embodiment, where steps 1210, 1215, 1220, 1225, 1230, and 1235 are the same as steps 810, 815, 820, 825, 830, and 835 in FIG. 7. Initially the BS 1202 sends configuration information to the UE 1206 for identifying a reference signal, in the example of FIG. 10 that being CSI-RS, via the RIS 1204. If no beam correspondence is found when using the initial configuration of RIS 1204, the BS 1202 then communicates with the RIS 1204 and the UE 1206 to configure the time division duplexing approach as described in further detail below.

After the BS 1202 has determined there is no beam correspondence, at step 1235 at step 1240, the BS 1202 informs the UE 1206 that beam correspondence does not hold and a TDD solution will be used. As part of the message sent to the UE 1206, the BS 1202 send configuration that includes timing information for different transmission resources. This may include start and end times for respective transmission resources, for example resources used for transmission for either UL and DL. In some embodiments, optionally, a guard time may be provided. The guard time may be provided explicitly, or implicitly, based on the start and end times for the transmission resources for each direction of communications. In some embodiments, the BS 1202 informing the UE 1206 that beam correspondence does not hold and a TDD solution will be used may be sent by the BS 1202 as higher layer signaling between the BS 1202 and UE 1206. The higher layer signaling may use existing higher layer signaling such as RRC signaling or may use a new signaling designed for this type of communication between the BS 1202 and UE 1206. In some embodiments, the BS 1202 may send the information to the UE 1206 using MAC-CE signaling.

Also similar to step 845 in FIG. 7, at step 1245, the RIS 1204 when configured for UL can be configured to redirect to the BS 1202 assuming different incident angles related to the accuracy of AoD estimation in DL.

At step 1250 the BS 1202 may send RIS configuration information to the RIS 1204 (i.e. possibly in the form of a redirection command) to perform proper redirection for each way of communication at each time. The RIS configuration information may include information such as information regarding how the RIS should be configured for the time durations for each of the DL and UL directions. The information regarding how the RIS should be configured for the transmission durations for each of the DL and UL directions may include one or more of: frequency information of the signal, AoA and AoD information, phase difference, beam-width and any other redirecting configuration information that could be used to configure the RIS for redirection. To perform proper reconfiguration at specific times, synchronization information may be provided in the RIS configuration information sent in step 1250 to enable synchronization between the RIS 1204 and the BS 1202. In some embodiments, the RIS configuration information may be sent by the BS 1202 as higher layer signaling between the BS 1202 and RIS 1204. The higher layer signaling may use existing higher layer signaling such as RRC signaling or may use a new signaling designed for this type of communication between the BS 1202 and RIS 1204. In some embodiments, the BS 1202 may send the indication to the RIS 1204 using MAC-CE signaling.

The base station 1202 and the UE 1206 transmit and receive 1255 data over the channel via the RIS 1204 as configured in 1245 and 1250.

In some embodiments, the RIS being used in a TDD fashion allows the RIS to perform a different beamforming for a respective transmission resource by using the RIS response and AoA/AoD values, when AoA/AoD are known. In some embodiments, the RIS being used in a TDD fashion allows the RIS to perform a different beamforming for a respective transmission resource by using narrow beam sweeping if AoA/AoD are not known with required accuracy. In some embodiments, the RIS being used in a TDD fashion allows tighter timing synchronization with the BS and UE.

In some embodiments, at the UE side, the TDD process allows the UE to maintain beam correspondence in the DL direction and the UL direction. In some embodiments, for example when the environment does not include other UEs, the UE may be informed about the guard time in its frame structure, which may be a function of the RIS response.

While numbered differently in FIGS. 11 and 12, it should be understood that BS 1110 and BS 1202 are the same, or a similar type of device, with similar capabilities. The same applies to UE 1120 and UE 1206 and RIS 1130 and RIS 1204.

In some embodiments, two spaced apart regions of RIS are utilized as shown in FIG. 13. FIG. 13 shows an arrangement of BS 1310, UE 1320, RIS1 1135 and RIS2 1130. A first region of RIS, RIS2 1330 is configured for one direction of communication (e.g. DL on beams 1340 and 1350) and a second region of RIS, RIS1 1335 is configured for the other direction of communication (e.g. UL on beams 1360 and 1370).

In some embodiments, the two spaced apart regions may be two separate RIS. In some embodiments, the two spaced apart regions may be on the same large RIS such that each of the spaced apart regions performs redirection in one way of communication. While similar to the example shown in FIG. 9A, the difference from that of FIG. 9A is that for two separate RISs or two spaced apart regions on a large RIS, the BS and the UE can focus their beams on the different RISs or different spaced apart region of the large RIS without impinging on the other RIS or region. Therefore, the problem of undesired redirected beams shown in FIG. 9A can be avoided. In some embodiments, the angle of incident wave at the RIS for both UL and DL can be similar. Therefore, when the beam matches the proper incident angle of the designated RIS, the RIS can provide wide-range of phase-shifts to maximize the signal strength at the destination.

While FIG. 13 is shown to include two portions, it is to be understood that the space apart portions of RIS or multiple separated RIS could be more than two portions of RIS or more that two RIS.

The signaling for embodiments using spaced apart regions shares some similarity to that of the wider beam embodiments as described with reference to FIG. 7. FIG. 14 is an example of a signaling flow diagram for a spaced apart RIS region embodiment, where steps 1410, 1415, 1420, 1425, 1430, and 1435 are the same as steps 810, 815, 820, 825, 830, and 835 in FIG. 7. Initially the BS 1410 sends configuration information to the UE 1406 for identifying a reference signal, in the example of FIG. 14 that being CSI-RS, via RIS1 1404 without using RIS2 1405. If no beam correspondence is found when using just RIS1 1404, the BS 1402 then communicates with RIS1 1404 for redirection from BS 1404 to UE 1406 via RIS1 1404 in the DL direction and from UE 1404 to BS 1406 via RIS2 1405 in the UL direction as described in further detail below.

After the BS 1402 has determined there is no beam correspondence, at step 1435 at step 1440, the BS 1402 informs the UE 1406 that beam correspondence does not hold for UL using RIS1 1404, i.e. the beam redirection in the UL is different than the beam redirection for DL, and another beam search is to be carried out for the UL transmission using RIS2 1405. In some embodiments, the BS 1402 informing the UE 1406 that beam correspondence does not hold for UL using RIS1 1404 and another beam search is to be carried out for the UL transmission using RIS2 1405 may be sent by the BS 1402 as higher layer signaling between the BS 1402 and UE 1406. The higher layer signaling may use existing higher layer signaling such as RRC signaling or may use a new signaling designed for this type of communication between the BS 1402 and UE 1406. In some embodiments, the BS 1402 may send the information to the UE 1406 using MAC-CE signaling.

At step 1445 the BS 1402 sends RIS configuration information to RIS1 1404 (e.g. possibly in the form of a redirection command) for sending data to the UE 1406 in DL, i.e. to be transmitted in step 1480 described below. The RIS signal configuration information may include information regarding how the RIS1 1404 should be configured for redirecting beams in the DL direction. In some embodiments, the BS 1402 knows the AoD from RIS2 1405 to the BS 1402 and the BS 1402 can configure RIS2 1405 to redirect from the UE 1406 to the BS 1402 assuming different AoA from the UE 1406 to RIS2 1405. In some embodiments, the RIS configuration information may be sent by the BS 1402 as higher layer signaling between the BS 1402 and RIS1 1404. The higher layer signaling may use existing higher layer signaling such as RRC signaling or may use a new signaling designed for this type of communication between the BS 1402 and RIS1 1404. In some embodiments, the BS 1402 may send the indication to the RIS1 1404 using MAC-CE signaling.

At step 1450 the BS 1402 sends RIS configuration information to RIS2 1405 (e.g. possibly in the form of a beam redirection command) for redirecting reference signals from the UE 1406 to the BS 1402. In some embodiments, the reference signal may be a sounding reference signal (S-RS). The RIS configuration information may include information regarding how the RIS should be configured for redirecting beams in the UL direction. The information regarding how RIS2 1405 should be configured may include one or more of: frequency information of the signal, AoA and AoD information, phase difference, beam-width and any other redirecting configuration information that could be used to configure the RIS for redirection. In some embodiments, the RIS configuration information may be sent by the BS 1402 as higher layer signaling between the BS 1402 and RIS2 1405. The higher layer signaling may use existing higher layer signaling such as RRC signaling or may use a new signaling designed for this type of communication between the BS 1402 and RIS2 1405. In some embodiments, the BS 1402 may send the indication to the RIS2 1405 using MAC-CE signaling.

At step 1455 the BS 1402 sends reference signal configuration information (e.g. possibly in the form of a S-RS configuration information) to the UE 1406 that identifies carrier frequencies of the reference signals that the UE 1406 should be transmit and be redirects by RIS2 1405 for UL channel estimation. This reference signal configuration information may include for example configuration information for the S-RS transmitted by the UE 1406 is to transmit to the BS 1402. In some embodiments, the reference signal configuration information may be sent by the BS 1402 as higher layer signaling between the BS 1402 and UE 1406. The higher layer signaling may use existing higher layer signaling such as RRC signaling or may use a new signaling designed for this type of communication between the BS 1402 and UE 1406. In some embodiments, the BS 1402 may send the indication to the UE 1406 using MAC-CE signaling.

While steps 1450 and 1455 are shown in a particular order, it should be understood that the order may be reversed.

The UE 1406 then performs beam sweeping by transmitting 1460 multiple S-RS in the direction of RIS2 1405 so that the RIS2 1405 can redirect the S-RS to the BS 1402. Once received at BS 1402, the BS 1402 can determine 1465 the AoA at RIS2 1405 for the UL transmission. At step 1470, the BS 1402 may feedback to the UE 1406 S-RS measurement information based on measurements performed by the BS of the S-RS. In some embodiments, the BS 1402 may send some feedback information related to the measurements made at the BS 1402 to the UE 1406. An example of such information may be a selected beam index for transmission (i.e. a beam index corresponding to a beam of a plurality of beams with a strongest signal strength received from the UE 1406 via the RIS2 1405) or channel estimation information. The S-RS measurement information may be physical layer signaling carried over PDCCH, RRC, or MAC-CE, or another downlink signaling.

At step 1475 the BS 1402 sends RIS configuration information (e.g. possibly in the form of a beam redirection command for RIS2 to redirected an UL transmission) to RIS2 1405 for configuring RIS2 1405 for redirecting data to the UE1406 in UL, i.e. as in step 1485 described below. The information regarding how RIS2 1405 should be configured may include one or more of: frequency information of the signal, AoA and AoD information, phase difference, or beam-width. In some embodiments, the RIS configuration information may be sent by the BS 1402 as higher layer signaling between the BS 1402 and RIS2 1405. The higher layer signaling may use existing higher layer signaling such as RRC signaling or may use a new signaling designed for this type of communication between the BS 1402 and RIS2 1405. In some embodiments, the BS 1402 may send the indication to the RIS2 1405 using MAC-CE signaling.

The base station 1402 and the UE 1406 transmit and receive 1480 DL data in the DL direction over the channel via the RIS1 1404 as configured in 1445. The base station 1402 and the UE 1406 transmit and receive 1485 UL data in the UL direction over the channel via the RIS2 1405 as configured in 1475.

In some embodiments, the spaced apart RISs allows the respective RISs to perform different beamforming by using independent measurement for UL and DL as different RISs are used to redirect the beams in the different directions.

In some embodiments, at the UE side, the spaced apart RISs allows the UE to perform independent measurement for UL/DL as there is one RIS being used for redirection in each direction allowing different UL and DL beams at UE.

While numbered differently in FIGS. 13 and 14, it should be understood that BS 1310 and BS 1402 are the same, or a similar type of device, with similar capabilities. The same applies to UE 1320 and UE 1406 and RIS1 1135, RIS2 1130, RIS1 1404 and RIS2 1405.

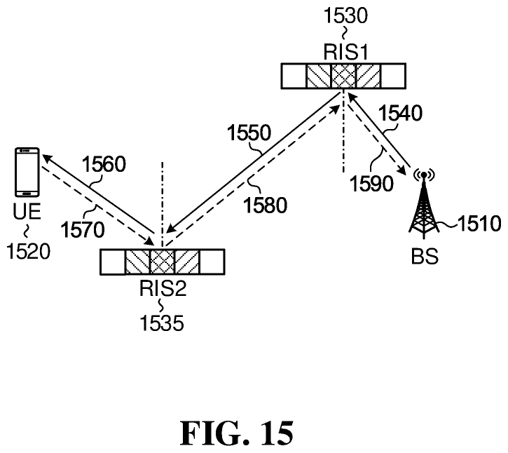

In some embodiments, when the material of the RIS is sensitive to the incident angle impinging on the device, for example LC. For some implementations where large RISs can be deployed on walls, different portions of RISs can be utilized for two-way redirection via multi-hop redirection as shown in FIG. 15. FIG. 15 shows an arrangement of BS 1510, UE 1520, RIS1 1530 and RIS2 1535. A DL direction communication is shown including beam 1540 from BS 1510 to RIS1 1530, beam 1550 from RIS1 1530 to RIS2 1535 and beam 1560 from RIS2 1535 to UE 1520. A UL direction communication is shown including beam 1570 from UE 1520 to RIS2 1535, beam 1580 from RIS2 1535 to RIS1 1530 and beam 1590 from RIS1 1530 to BS 1510. Note that for each of RIS1 and RIS 2, the AoA and AoD are analogues in both directions of communication. While two RIS are shown in FIG. 15, it should be understood that more than two RIS could be used.

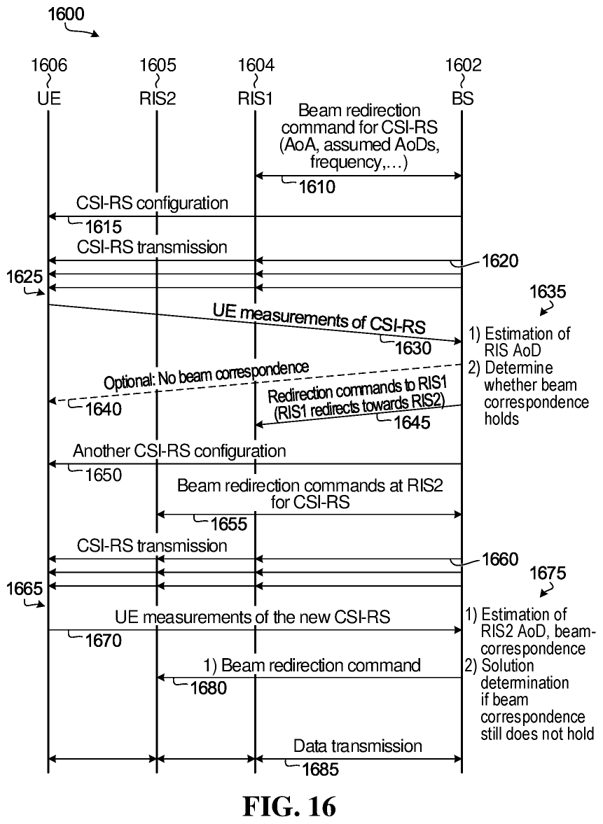

The signaling for embodiments using separate RISs shares some similarity to that of the wider beam embodiments as described with reference to FIG. 7. FIG. 16 is an example of a signaling flow diagram for a separate RISs embodiment, where steps 1610, 1615, 1620, 1625, 1630, and 1635 are the same as steps 810, 815, 820, 825, 830, and 835 in FIG. 7. Initially the BS 1602 sends configuration information to the UE 1606 for receiving CSI-RS via the RIS1 1604 without using RIS2 1605. If no beam correspondence is found when using just RIS1 1604, the BS 1602 then communicates with RIS1 1604 and RIS2 1605 for measurement and configuration to attempt redirection from BS 1602 to RIS1 1604 to RIS2 1605 to UE 1606.

After step 1635, when it is determined that there is no beam correspondence using just RIS1 1604, at step 1640, the BS 1602 may optionally inform the UE 1606 that there is no beam correspondence and another beam sweeping for DL communication should be performed, in which RIS2 1605 will be used in addition to RIS1 1604. In some embodiments, the BS 1602 informing the UE 1606 that beam correspondence does not hold for DL using only RIS1 1604 and another beam search is to be carried out for the DL transmission using both RIS1 1604 and RIS2 1605 may be sent by the BS 1602 as higher layer signaling between the BS 1602 and UE 1606. The higher layer signaling may use existing higher layer signaling such as RRC signaling or may use a new signaling designed for this type of communication between the BS 1602 and UE 1606. In some embodiments, the BS 1602 may send the information to the UE 1606 using MAC-CE signaling.

At step 1645 BS 1602 sends RIS configuration information (e.g. possibly in the form of a beam redirection command for RIS1) to RIS1 1604 to redirect a signal from BS 1602 to RIS2 1605 or from RIS2 1605 to BS 1602, i.e. as in step 1685 described below. In some embodiments, the RIS configuration information may be sent by the BS 1602 as higher layer signaling between the BS 1602 and RIS1 1604. The higher layer signaling may use existing higher layer signaling such as RRC signaling or may use a new signaling designed for this type of communication between the BS 1602 and RIS1 1604. In some embodiments, the BS 1602 may send the indication to the RIS1 1404 using MAC-CE signaling.

At step 1650, the BS 1602 sends reference signal configuration information (e.g. possibly in the form of a CSI-RS configuration information) to the UE 1606 that includes information about the CSI-RS signaling that is to be sent by the BS 1602 to the UE 1606 via redirection by RIS1 1604 and RIS2 1605. For example, this may include the type of reference signal, in this example CSI-RS, scheduling formation, etc.

At step 1655, the BS 1602 sends RIS configuration information to RIS2 1605 (e.g. possibly in the form of a beam redirection command) to configure RIS2 1605 to redirect multiple directions of assumed AoD of the CSI-RS configured in step 1650 from RIS2 1605 (received from BS 1602 via RIS1 1604) to the UE 1606. The information regarding how RIS2 1605 should be configured may include one or more of: frequency information of the signal, AoA and AoD information, phase difference, and beam-width. In some embodiments, the RIS configuration information may be sent by the BS 1602 as higher layer signaling between the BS 1602 and RIS2 1605. The higher layer signaling may use existing higher layer signaling such as RRC signaling or may use a new signaling designed for this type of communication between the BS 1602 and RIS2 1605. In some embodiments, the BS 1602 may send the indication to the RIS2 1605 using MAC-CE signaling.

While steps 1650 and 1655 are shown in a particular order, it should be understood that the order may be reversed.

At step 1660, BS 1602 sends the reference signals (CSI-RS signals in FIG. 16) to be redirected by RIS1 1604 and RIS2 1605 in the direction of UE 1606. At step 1665, the UE 1606 performs measurements on the CSI-RS.

At step 1670, the UE 1606 sends to the BS 1602 measurement feedback information based on measurements performed by the BS of the CSI-RS. The measurement feedback information may be physical layer signaling carried over PUCCH, PUSCH, or another type of uplink signaling.

At step 1675, the BS 1602 determines whether beam correspondence holds based on the feedback measurement information received from the UE 1606. Determining whether beam correspondence holds may involve the BS determining the AoD for the RIS2 1605 based on the feedback measurement information received at step 1670. If beam correspondence is found using both RIS1 1604 and RIS2 1605 in combination, at step 1680, two-way data communication is established among these two RISs and the BS 1602 sends an indication to that effect to the RIS2 1605, including RIS configuration information (e.g. possibly in the form of a beam redirection command) for configuring RIS2 1605 to redirect data to the UE1606 in DL and to the BS 1606 in UL, i.e. as in step 1685 described below. The information regarding how RIS2 1605 should be configured may include one or more of: frequency information of the signal, AoA and AoD information, phase difference, and beam-width. In some embodiments, the RIS configuration information may be sent by the BS 1602 as higher layer signaling between the BS 1602 and RIS2 1605. The higher layer signaling may use existing higher layer signaling such as RRC signaling or may use a new signaling designed for this type of communication between the BS 1602 and RIS2 1605. In some embodiments, the BS 1602 may send the indication to the RIS2 1405 using MAC-CE signaling.

In some embodiments, (not shown in FIG. 16) UL S-RS measurements may be performed via RIS2 1605 only or via RIS2 1605 and RIS1 1604 in order to decide more accurate AoA at RIS2 from the UE 1606 in UL (or AoD in DL). They may be similar to steps 1450, 1455, 1460, 1465 and 1470 shown in FIG. 14.

The base station 1602 and the UE 1606 transmit and receive 1685 data in the DL direction over the channel via the RIS1 1604 as configured in 1605.

If beam correspondence still does not hold, for example as indicated in step 1675, an alternative solution for signal transmission may be determined. In some embodiments, the process may be repeated with a third RIS (not shown) that may be located in a different position than RIS2 1605 and which could redirect a signal that was redirected by RIS1 1604, or a different portion of RIS2 1605 when used with RIS1 1604, or a different portion of RIS1 1604 when used with RIS2 1605. This may include repeating steps 1645, 1650, 1655, 1660, 1665, 1670, and 1675 between when using a different RIS or a different portion of RIS2 1605 or most or all of the steps if a different portion of RIS1 1604 is used with a second RIS.

While numbered differently in FIGS. 15 and 16, it should be understood that BS 1510 and BS 1602 are the same, or a similar type of device, with similar capabilities. The same applies to UE 1520 and UE 1606 and RIS1 1530, RIS2 1535, RIS1 1604 and RIS2 1605.

The various embodiments described above may be beneficial for two-way communication via one or more RIS as they facilitate two-way redirection when beam correspondence without the proposed method does not hold.

In some embodiments, the network or the BS can determine whether beam-correspondence holds, and can select one of the methods described above to be used when beam correspondence does not hold.

In some embodiments, one or more of the methods described above may improve the throughput and reliability for UL and DL communication via RIS. More specifically, when beam correspondence does not hold, the reliability of one of the directions of communication may deteriorate if the signal does not reach the destination due to a lack of beam correspondence. However, the methods described above provide different potential solutions for maintaining adequate signal strength for the communications in both directions.

In some embodiments, one or more of the methods described above may reduce the amount of measurement performed for non-reciprocal RIS. This is because when the channel is estimated for one-way of communication (e.g. DL), the RIS can still perform some beam sweeping for the other-way of communication (UL), but only considering the range of accuracy of the channel that has already been estimated (DL).

While the BS, UE and RIS are numbered differently in the various examples above, it should be understood that the BS, UE, and RIS in any of the examples of FIGS. 7 to 16 may be capable of operating as described in one or more of the other examples.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
sending, by a transmitter, first configuration information to configure a reconfigurable intelligent surface (RIS) to redirect a signal over a range of directions;
sending, by the transmitter, second configuration information pertaining to reference signals that are transmitted by the transmitter and redirected in a direction of a receiver by the RIS;
sending, by the transmitter, the reference signals;
receiving, by the transmitter, a measurement report from the receiver identifying measurements of the reference signals performed by the receiver; and
when there is a lack of beam correspondence between a signal transmitted by the transmitter and redirected by the RIS in the direction of the receiver and a signal transmitted by the receiver and redirected by the RIS in a direction of the transmitter, selecting a manner of reconfiguring the RIS to compensate for the lack of beam correspondence.

2. The method of claim 1 further comprising the transmitter:
determining whether there is beam correspondence; or
receiving an indication from the receiver or a network as to whether there is beam correspondence.

3. The method of claim 2, wherein the determining, by the transmitter, whether there is beam correspondence comprises making the determination based on one or more of:
a frequency resource used for transmissions made from the transmitter and a frequency resource used for transmissions made from the receiver;
an angle of arrival (AoA) of a beam incident on the RIS and an angle of departure (AoD) of a beam redirected by the RIS;
a difference between an AoA of a beam incident on the RIS and an AoD of a beam redirected by the RIS;
accuracy of estimating an AoA and/or angle of AoD at the RIS;
beam width for the incident and redirected signals at RIS; or
a RIS type.

4. The method of claim 1, wherein selecting the manner of reconfiguring the RIS to compensate for the lack of beam correspondence comprises selecting the manner of reconfiguring the RIS from a group, the group comprising:
configuring the RIS to redirect a signal from either the transmitter or the receiver via beams that encompass an expected deviation from a desired redirection angle in bi-directional communication while the signal reaches a destination in both directions of communication with a strength that satisfies a threshold;
configuring the RIS to be partitioned into two or more surface portions, wherein at least one surface portion is configured to redirect a beam from the transmitter to the receiver and a different at least one surface portion is configured to redirect a beam from the receiver to the transmitter;
configuring each of a plurality of RIS, wherein at least one RIS of the plurality of RIS is configured to redirect a beam from the transmitter to the receiver and at least one RIS of the plurality of RIS is configured to redirect a beam from the receiver to the transmitter; and
configuring the RIS based on time division multiplexing to allow the RIS to redirect from the transmitter to the receiver and from the receiver to the transmitter during different transmission resources.

5. The method of claim 1 further comprising one or more of:
sending, by the transmitter, third configuration information to configure the RIS to redirect a signal from either the transmitter or the receiver via beams that encompass an expected deviation from a desired redirection angle;
sending, by the transmitter, third configuration information to configure the RIS to partition the RIS into two or more surface portions, wherein at least one surface portion is configured to redirect a signal from the transmitter to the receiver and a different at least one surface portion is configured to redirect a signal from the receiver to the transmitter;
sending, by the transmitter, third configuration information to configure each of the plurality of RISs, to redirect a signal from the transmitter to the receiver or redirect a signal from the receiver to the transmitter;
sending, by the transmitter, third configuration information to configure the RIS based on time division multiplexing to redirect from the transmitter to the receiver and from the receiver to the transmitter at different transmission resources; or
sending, by a transmitter, third configuration information to configure the RIS to redirect a signal from the receiver to the transmitter considering a range of directions of incident signal from the receiver to the RIS.

6. The method of claim 1 further comprising:
receiving, by the transmitter, reference signals from the receiver that have been redirected by the RIS;
measuring, by the transmitter, the received reference signals; and
sending, by the transmitter, a measurement report to the receiver identifying measurements of the reference signals at the transmitter.

7. The method of claim 2 further comprising:
sending, by the transmitter, a notification that signal power of a redirected signal is reduced.

8. The method of claim 3, further comprising sending, by the transmitter, fourth configuration information, the four configuration information comprising timing information for different transmission recourses.

9. The method of claim 1 further comprising:
receiving, by the transmitter, a signal that has been redirected by the RIS via a beam that encompass an expected deviation from a desired redirection angle from the receiver with a strength that satisfies a threshold; or
transmitting, by the transmitter, a signal that will be redirected by the RIS to the receiver via a beam that encompass an expected deviation from a desired redirection angle to the receiver with a strength that satisfies a threshold.

10. The method of claim 1 further comprising:
receiving, by the transmitter, a signal that has been redirected by at least one surface portion of the RIS; or
transmitting, by the transmitter, a signal that will be redirected by at least one different surface portion of the RIS.

11. The method of claim 1 further comprising:
receiving, by the transmitter, a signal that has been redirected by at least one RIS of a plurality of RIS; or
transmitting, by the transmitter, a signal that will be redirected by at least one different RIS of a plurality of RIS than used for receiving a signal that has been redirected by the at least one RIS of a plurality of RIS.

12. The method of claim 1 further comprising:
receiving, by the transmitter, a signal that has been redirected by the RIS during a first transmission resource; or
transmitting, by the transmitter, a signal that will be redirected by the RIS during a second transmission resource.

13. An apparatus comprising:
one or more processors; and
a computer-readable memory having stored thereon processor executable instructions, that when executed, perform a method according to claim 1.

14. A method comprising:
receiving, by a reconfigurable intelligent surface (RIS), first configuration information to configure the RIS to redirect a signal over a range of directions;
redirecting, by the RIS, reference signals incident on the RIS, from a transmitter, toward a receiver, the reference signals used to determine whether there is beam correspondence between a signal transmitted by the transmitter and redirected by the RIS in a direction of the receiver and a signal transmitted by the receiver and redirected by the RIS in a direction of the transmitter; and
when there is a lack of beam correspondence, receiving, by the RIS, second configuration information for configuring the RIS to compensate for the lack of beam correspondence.

15. The method of claim 14, wherein the lack of beam correspondence is based on one or more of:
a frequency resource used for transmissions made from the transmitter is different than a frequency resource used for transmissions made from the receiver;
an angle of arrival (AoA) of a beam incident on the RIS is different than an angle of departure (AoD) of a beam redirected by the RIS;
a difference between an AoA of a beam incident on the RIS and an AoD of a beam redirected by the RIS;
accuracy of estimating an AoA and/or angle of AoD at the RIS;
beam width for the incident and redirected signals at RIS; or
a RIS type.

16. The method of claim 14, wherein receiving, by the RIS, the second configuration information for configuring the RIS to compensate for the lack of beam correspondence comprises:
receiving, by the RIS, configuration information to configure the RIS to redirect a signal from either the transmitter or the receiver via beams that encompass an expected deviation from a desired redirection angle in bi-directional communication while the signal reaches a destination in both directions of communication with a strength that satisfies a threshold;
receiving, by the RIS, configuration information to configure the RIS to partition the RIS into two or more surface portions, wherein at least one surface portion is configured to redirect a signal from the transmitter to the receiver and a different at least one surface portion is configured to redirect a signal from the receiver to the transmitter;
receiving, by the RIS, configuration information to configure the RIS, to redirect a signal from the transmitter to the receiver or redirect a signal from the receiver to the transmitter; and
receiving, by the RIS, configuration information to configure the RIS based on time division multiplexing to redirect from the transmitter to the receiver and redirect from the receiver to the transmitter in different transmission resources.

17. The method of claim 14 further comprising at least one of:
configuring, by the RIS, the surface of the RIS to redirect a signal from either the transmitter or the receiver via a beam that encompass an expected deviation from a desired redirection angle;
configuring, by the RIS, the surface of the RIS to partition the RIS into at least two surface portions, wherein at least one surface portion is configured to redirect a signal from the transmitter to the receiver and a different at least one surface portion is configured to redirect a signal from the receiver to the transmitter;
configuring, by the RIS, the surface of the RIS to redirect a beam from the transmitter to the receiver or redirect a beam from the receiver to the transmitter;
configuring, by the RIS, based on time division multiplexing to redirect from the transmitter to the receiver and redirect from the receiver to the transmitter in different transmission resources; or
configuring, by a RIS, the surface of the RIS to redirect a signal from the receiver to the transmitter considering a range of directions of incident signal from the receiver to the RIS.

18. The method of claim 14 further comprising:
redirecting, by the RIS, reference signals sent from the receiver to the transmitter to be used by the transmitter to measure and determine an appropriate value of the angle of arrive of a beam incident on the RIS from the receiver.
